(19) United States
(12) Patent Application Publication
(10) Pub. No.: US 2025/0045083 A1
(43) Pub. Date: Feb. 6, 2025

(54) DISTRIBUTED CONTROL PLANE IN A DEVELOPMENT ENVIRONMENT

(71) Applicant: Snowflake Inc., Bozeman, MT (US)

(72) Inventors: Daniel Geoffrey Karp, San Carlos, CA (US); Themistoklis Melissaris, San Bruno, CA (US); Kunal Prafulla Nabar, Burlingame, CA (US); Samir Rehmtulla, San Mateo, CA (US)

(21) Appl. No.: 18/362,587

(22) Filed: Jul. 31, 2023

(51) Int. Cl. G06F 9/455

(52) U.S. Cl. CPC G06F 9/45558; G06F 2009/45562; G06F 2009/45566; G06F 2009/4557; G06F 2009/45595

(57) ABSTRACT

Provided herein are systems and methods for distributed control plane enablement in a development environment of a database system. A first provisioning request for configuring a control plane environment at a computing node of a database system is decoded. The control plane environment corresponds to a control plane of the database system. A first VM cluster and a second VM cluster are instantiated at the computing node based on the first provisioning request. A cluster manager VM is instantiated within the first VM cluster. The cluster manager VM is configured with at least one control plane management function of the control plane environment. At least one foreground VM is instantiated within the first VM cluster. The at least one foreground VM is configured with at least one query processing function. A query received by the computing node is processed using the at least one query processing function.

### TECHNICAL FIELD

Embodiments of the disclosure relate generally to control plane configuration in a database system and, more specifically, to distributed control plane enablement in a development environment of the database system.

### BACKGROUND

Databases are widely used for data storage and access in computing applications. A goal of database storage is to provide enormous sums of information in an organized manner so that it can be accessed, managed, updated, and shared. In a database, data may be organized into rows, columns, and tables. Databases are used by various entities and companies for storing information that may need to be accessed or analyzed. However, the configuration of a control plane in a database system, including the configuration of a control plane associated with a development environment for developing and testing new and existing functionalities, can be challenging and time-consuming.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system that is in communication with a cloud-storage platform and is using a control plane manager (CPM), in accordance with some embodiments of the present disclosure.

FIG. 2 is a block diagram illustrating the components of a compute service manager including a CPM, in accordance with some embodiments of the present disclosure.

FIG. 3 is a block diagram illustrating components of an execution platform, in accordance with some embodiments of the present disclosure.

FIG. 4 illustrates an example regional-deployment map for the example database system of FIG. 1, in accordance with some embodiments of the present disclosure.

FIG. 5 illustrates another view of the computing environment of FIG. 1 including control plane services (CPS), an execution platform, and object storage, in accordance with some embodiments of the present disclosure.

FIG. 6 is a more detailed diagram of the CPS and the execution platform of the computing environment of FIG. 5, in accordance with some embodiments of the present disclosure.

FIG. 7 is a screenshot of an example CPS deployment with control plane instances in a network-based service infrastructure, in accordance with some embodiments of the present disclosure.

FIG. 8 is a screenshot of the example CPS deployment of FIG. 7 with example mapping of accounts and services to virtual machine (VM) clusters and packages, in accordance with some embodiments of the present disclosure.

FIG. 9 is a diagram of a CPS deployment in a development environment using multiple CPS VMs, in accordance with some embodiments of the present disclosure.

FIG. 10 is a screenshot of an example CPS deployment with control plane instances in a Bootstrap cluster in a development environment, in accordance with some embodiments of the present disclosure.

FIG. 11 is a screenshot of the example CPS deployment of FIG. 10 with example mapping of accounts and services to VM clusters and packages, in accordance with some embodiments of the present disclosure.

FIG. 12 is a screenshot of an example CPS deployment with control plane instances of a background and a foreground VM cluster of a development environment in testing mode, in accordance with some embodiments of the present disclosure.

FIG. 13 is a screenshot of the example CPS deployment of FIG. 12 with an example mapping of accounts and services to the foreground VM cluster and packages, in accordance with some embodiments of the present disclosure.

FIG. 14 is a diagram of a CPS deployment in a development environment with package and multi-package support, in accordance with some embodiments of the present disclosure.

FIG. 15 is a diagram of a CPS deployment in a development environment with lifecycle management support, in accordance with some embodiments of the present disclosure.

FIG. 16 is a diagram of a CPS deployment in a development environment with corresponding configuration files for each of the CPS VMs in the deployment, in accordance with some embodiments of the present disclosure.

FIG. 17 is a diagram of a CPS deployment in a development environment with local provisioning of VMs using a local provisioning script, in accordance with some embodiments of the present disclosure.

FIG. 18 illustrates query processing functionalities that can be configured using a CPS deployment in a development environment, in accordance with some embodiments of the present disclosure.

FIG. 19 illustrates query processing functionalities that can be configured using a CPS deployment in a development environment, in accordance with some embodiments of the present disclosure.

FIG. 20 illustrates query processing functionalities that can be configured using a CPS deployment in a development environment, in accordance with some embodiments of the present disclosure.

FIG. 21 illustrates query processing functionalities that can be configured using a CPS deployment in a development environment, in accordance with some embodiments of the present disclosure.

FIG. 22 illustrates query processing functionalities that can be configured using a CPS deployment in a development environment, in accordance with some embodiments of the present disclosure.

FIG. 23 is a flow diagram illustrating the operations of a database system in performing a method for distributed control plane enablement in a development environment, in accordance with some embodiments of the present disclosure.

FIG. 24 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In the present disclosure, physical units of data that are stored in a data platform—and that make up the content of, e.g., database tables in user accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the data platform, a given file is referred to herein as an “internal file” and may be stored in (or at, or on, etc.) what is referred to herein as an “internal storage location.” If stored external to the data platform, a given file is referred to herein as an “external file” and is referred to as being stored in (or at, or on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, extensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a user account. The data platform may include one or more databases that are respectively maintained in association with any number of user accounts (e.g., accounts of one or more data providers or other types of users), as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata (e.g., account object metadata) in association with the data platform in general and in association with, for example, particular databases and/or particular user accounts as well. Users and/or executing processes that are associated with a given user account may, via one or more types of clients, be able to cause data to be ingested into the database, and may also be able to manipulate the data, add additional data, remove data, run queries against the data, generate views of the data, and so forth.

In an implementation of a data platform, a given database (e.g., a database maintained for a user account) may reside as an object within, e.g., a user account, which may also include one or more other objects (e.g., users, roles, privileges, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

Aspects of the present disclosure provide techniques for distributed control plane enablement in a development environment. The disclosed techniques deliver a realistic approach towards running a distributed control plane in the development environment, allowing control plane developers to run a complex distributed control plane and set up a minimal deployment locally on their development laptops for testing, validation, and experimentation.

Some existing techniques for simulation environments include simulators for distributed computer network routing and reachability analysis. Simulation tools also exist for Named Data Networking (NDN) control planes. However, such existing tools do not support functionality to enable a distributed control plane in a local development environment.

In this regard, the disclosed techniques provide several advantages over existing simulation-based solutions. For example, the disclosed techniques enable a richer set of the control plane functionality locally, providing developers with a localized version of cloud-based production infrastructure. As a result, the disclosed techniques provide an improved testing experience and reduce the time and cost of deploying code changes to the cloud infrastructure used for testing. In some aspects, a control plane manager (CPM) of a network-based database system configures a control plane deployment in a development environment. For example, the CPM can execute a localized deployment (instead of running the functionality on a cloud infrastructure) that allows for the creation of multiple clusters of instances. On the cloud infrastructure, these instances correspond to virtual machines (VMs). Local instances (which can also be referred to as local VMs) can be used for running the control plane's cluster management. The disclosed techniques enable a fully functional control plane deployment in a development environment including enabling the provisioning of local instances, support for code management, local provisioning including code deployment on the local instances, support for multiple code versions including package and multi-package support, and instance lifecycle support including support for rollout and rollback.

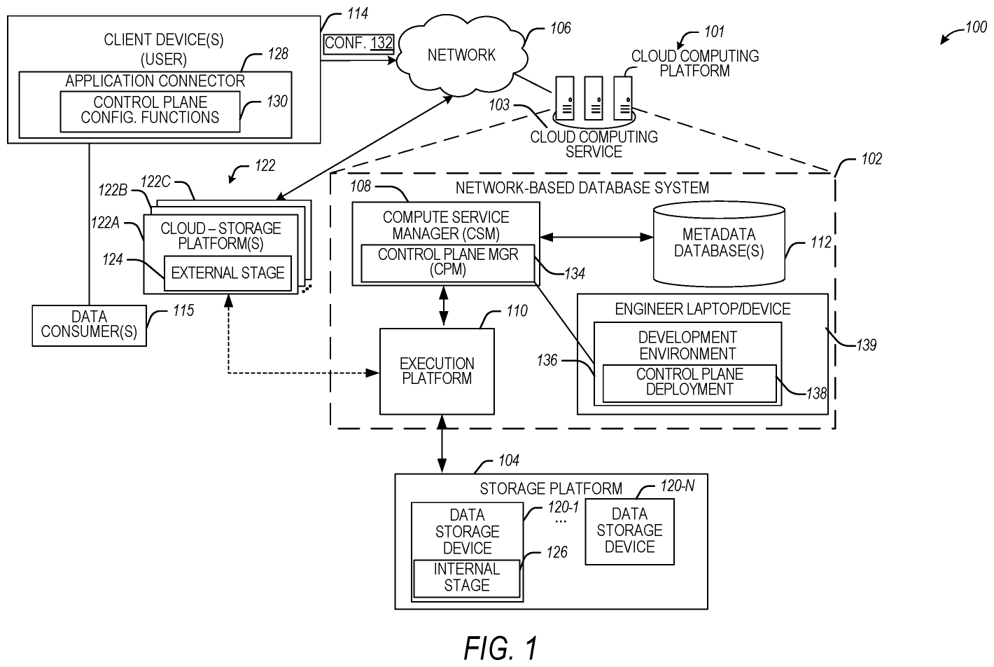

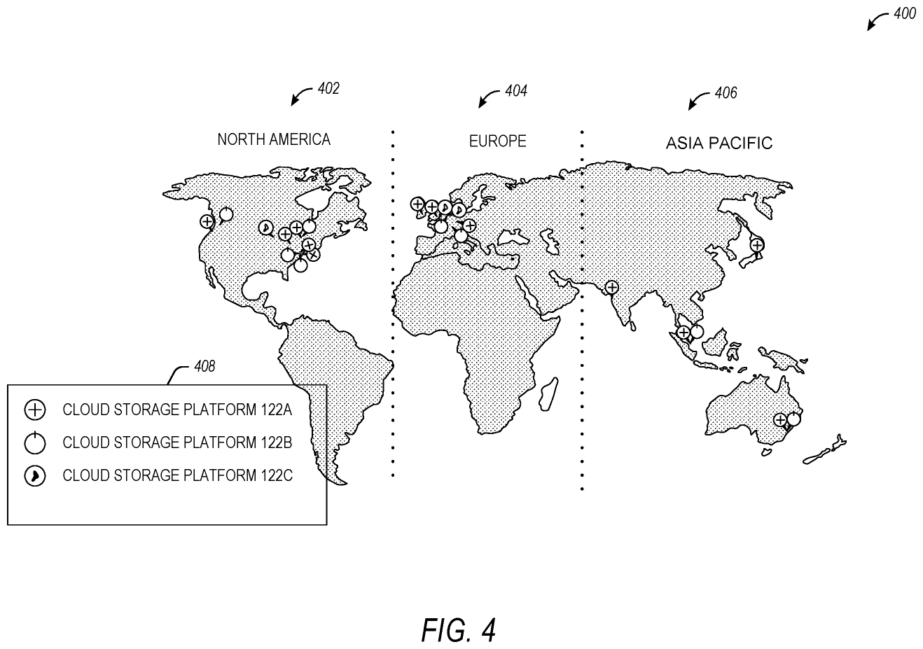

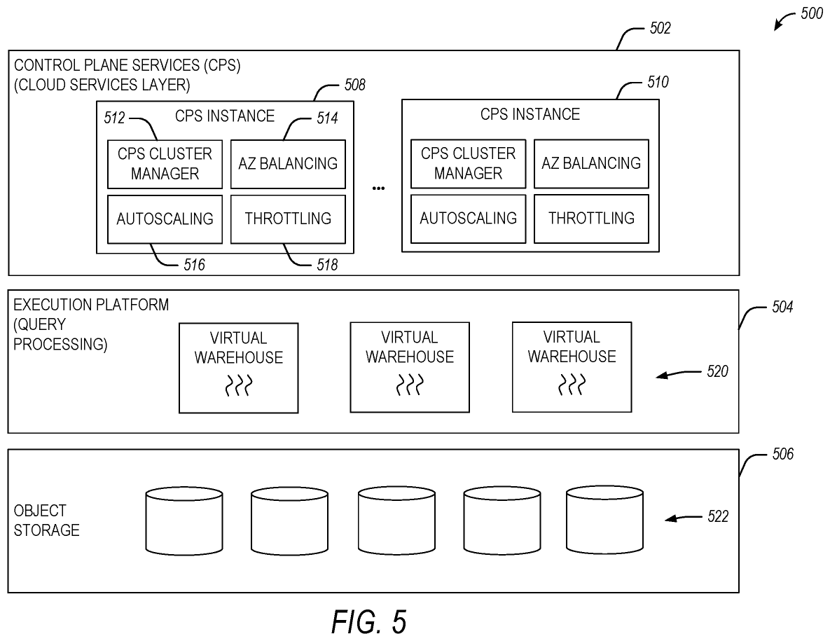

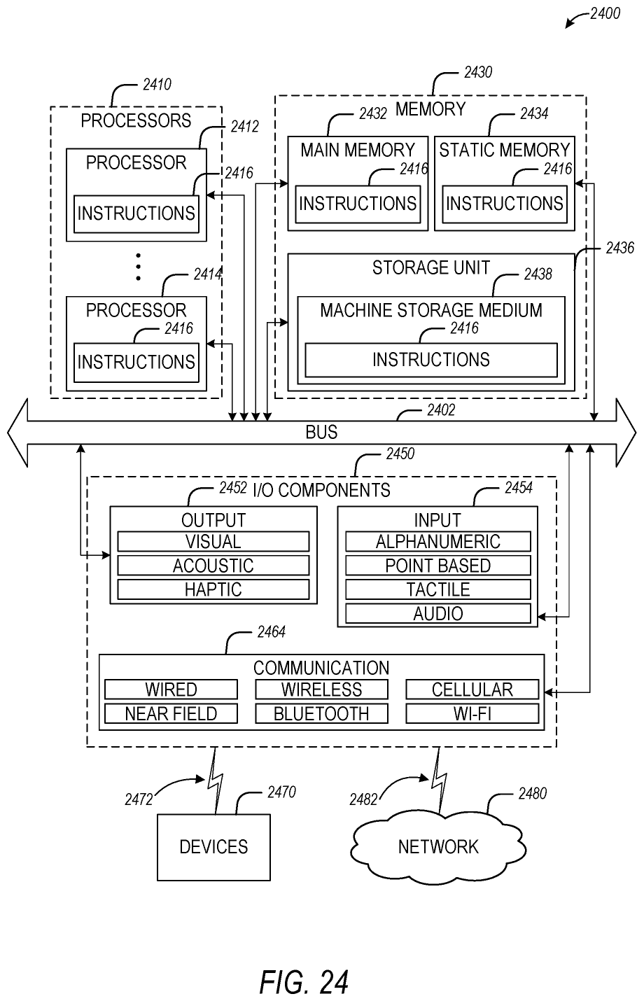

The various embodiments that are described herein are described with reference where appropriate to one or more of the various figures. An example computing environment with a CPM configured to perform the disclosed techniques are discussed in connection with FIGS. 1-3. An example multi-deployment arrangement is discussed in connection with FIG. 4. Additional database system arrangements and control plane deployment configurations are discussed in connection with FIG. 5-FIG. 23. A more detailed discussion of example computing devices that may be used with the disclosed techniques is provided in connection with FIG. 24.

FIG. 1 illustrates an example computing environment 100 including a network-based database system 102 which is in communication with a cloud-storage platform and is using a control plane manager (CPM), in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform. For example, in some aspects, the computing environment 100 may include a cloud computing platform 101 with the network-based database system 102, and a storage platform 104 (also referred to as a cloud-storage platform). The cloud computing platform 101 provides computing resources and storage resources that may be acquired (purchased) or leased and configured to execute applications and store data.

The cloud computing platform 101 may host a cloud computing service 103 that facilitates storage of data on the cloud computing platform 101 (e.g., data management and access) and analysis functions (e.g. SQL queries, analysis), as well as other processing capabilities (e.g., configuring and performing network intrusion event detection and response as described herein). The cloud computing platform 101 may include a three-tier architecture: data storage (e.g., storage platform 104 and storage platforms 122), an execution platform 110 (e.g., providing query processing), and a compute service manager 108 providing cloud services including services associated with the disclosed functionalities.

It is often the case that organizations that are users of a given data platform also maintain data storage (e.g., a data lake) that is external to the data platform (i.e., one or more external storage locations). For example, a company could be a user of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The user's servers and cloud-storage platforms are both examples of what a given user could use as what is referred to herein as an external storage location. The cloud computing platform 101 could also use a cloud-storage platform as what is referred to herein as an internal storage location concerning the data platform.

From the perspective of the network-based database system 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given user stores at a given external storage location may or may not be stored in an external stage in the external storage location—i.e., in some data-platform implementations, it is a user's choice whether to create one or more external stages (e.g., one or more external-stage objects) in the user's data-platform account as an organizational and functional construct for conveniently interacting via the data platform with one or more external files.

As shown, the network-based database system 102 of the cloud computing platform 101 is in communication with the storage platforms 104 and 122 (e.g., AWS®, Microsoft Azure Blob Storage®, or Google Cloud Storage). The network-based database system 102 is a network-based system used for reporting and analysis of integrated data from one or more disparate sources including one or more storage locations within the storage platform 104. The storage platform 104 comprises a plurality of computing machines and provides on-demand computer system resources such as data storage and computing power to the network-based database system 102.

The network-based database system 102 comprises a compute service manager 108, an execution platform 110, and one or more metadata databases 112. The network-based database system 102 hosts and provides data reporting and analysis services to multiple client accounts. In some aspects, the compute service manager 108 is also referred to as control plane services (CPS) or cloud services (e.g., as illustrated in FIG. 5).

The compute service manager 108 coordinates and manages operations of the network-based database system 102. The compute service manager 108 also performs query optimization and compilation as well as managing clusters of computing services that provide compute resources (also referred to as “virtual warehouses”). The compute service manager 108 can support any number of client accounts such as end-users providing data storage and retrieval requests, system administrators managing the systems and methods described herein, and other components/devices that interact with compute service manager 108.

The compute service manager 108 is also in communication with a client device 114. The client device 114 corresponds to a user of one of the multiple client accounts supported by the network-based database system 102. A user may utilize the client device 114 to submit data storage, retrieval, and analysis requests to the compute service manager 108. Client device 114 (also referred to as a user device) may include one or more of a laptop computer, a desktop computer, a mobile phone (e.g., a smartphone), a tablet computer, a cloud-hosted computer, cloud-hosted serverless processes, or other computing processes or devices may be used to access services provided by the cloud computing platform 101 (e.g., cloud computing service 103) by way of a network 106, such as the Internet or a private network. In some embodiments, the user of the client device 114 can be a data provider configured to provide services to other users such as data consumers 115.

In the description below, actions are ascribed to users of the network-based database system. Such actions shall be understood to be performed concerning client device 114 (or multiple client devices) operated by such users. For example, a notification to a user may be understood to be a notification transmitted to the client device 114, input or instruction from a user may be understood to be received by way of the client device 114, and interaction with an interface by a user shall be understood to be interaction with the interface on the client device 114. In addition, database operations (joining, aggregating, analysis, etc.) ascribed to a user of the network-based database system shall be understood to include performing such actions by the cloud computing service 103 in response to an instruction from that user.

In some embodiments, the client device 114 is configured with an application connector 128, which can perform control plane configuration functions 130. For example, client device 114 can be associated with a user of the network-based database system 102 (e.g., a data provider or another type of user) using the cloud computing service 103 of the network-based database system 102. In some embodiments, a user of client device 114 can be associated with the network-based database system 102 (e.g., the user is a development engineer) and can use the control plane configuration functions 130 to generate configurations 132. Configurations 132 can be used to configure one or more functions performed by the control plane manager (CPM) 134. For example, the CPM 134 can use configurations 132 in connection with setting up a control plane deployment 138 in the development environment 136 (e.g., on a device of the development engineer such as the engineer's laptop) or other control plane deployment functions discussed in connection with FIG. 5-FIG. 23.

The compute service manager 108 is also coupled to one or more metadata databases 112 that store metadata about various functions and aspects associated with the network-based database system 102 and its users. For example, the one or more metadata databases 112 may include a summary of data stored in remote data storage systems as well as data available from a local cache. Additionally, the one or more metadata databases 112 may include information regarding how data is organized in remote data storage systems (e.g., the storage platform 104) and the local caches. Information stored by the one or more metadata databases 112 allows systems and services to determine whether a piece of data needs to be accessed without loading or accessing the actual data from a storage device. In some embodiments, the one or more metadata databases 112 is configured to store account object metadata (e.g., account objects used in connection with a replication group object).

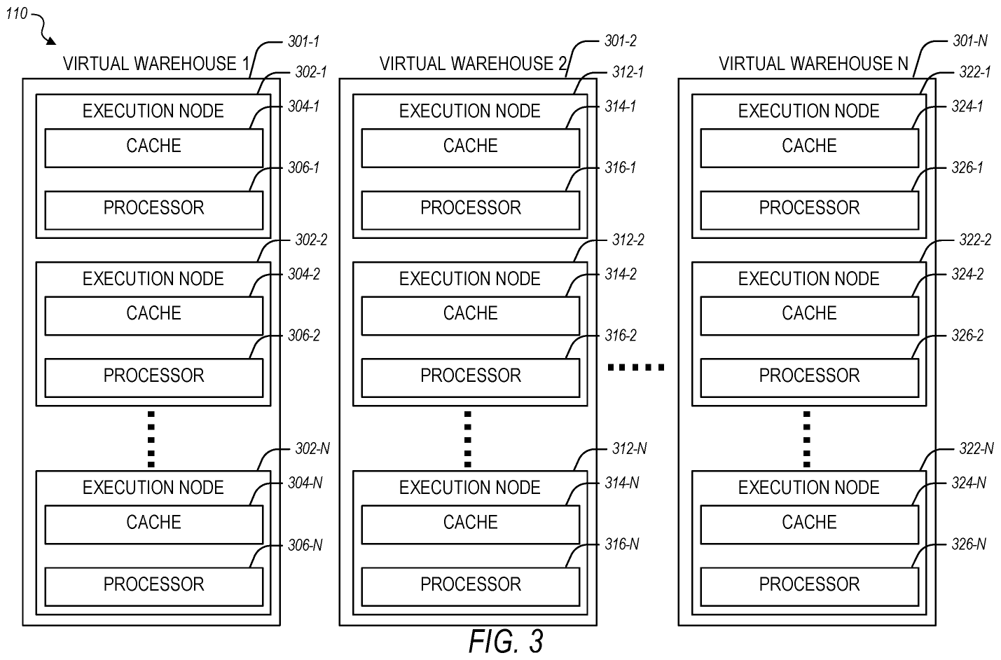

The compute service manager 108 is further coupled to the execution platform 110, which provides multiple computing resources that execute various data storage and data retrieval tasks. As illustrated in FIG. 3, the execution platform 110 comprises a plurality of compute nodes. The execution platform 110 is coupled to storage platform 104 and cloud-storage platforms 122A, 122B, . . . , 122C (collectively referred to as storage platforms 122). The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data-storage technology. Additionally, the storage platform 104 may include distributed file systems (such as Hadoop Distributed File Systems (HDFS)), object storage systems, and the like. In some embodiments, at least one internal stage 126 may reside on one or more of the data storage devices 120-1-120-N, and the external stage 124 may reside on one or more of the storage platforms 122.

In some embodiments, the compute service manager 108 includes a CPM 134. The CPM 134 comprises suitable circuitry, interfaces, logic, and/or code and is configured to perform the disclosed functionalities associated with distributed control plane enablement in a development environment. For example, CPM 134 configures disclosed functionalities associated with the configuration of a control plane deployment 138 in a development environment 136 of the network-based database system 102. As illustrated in FIG. 1, the development environment 136 is configured on an engineer/developer laptop 139 (or another device used by the engineers/developers of the network-based database system 102).

In some aspects, CPM 134 enables the execution of control plane code in the development environment 136. In some embodiments, CPM 134 creates the control plane deployment 138 as a minimal deployment in the development environment 136. For example, the minimal deployment can map control plane services to a minimal set of instances to reduce the number of processes running locally in the development environment 136 (which can be configured on the development engineer's laptop) and conserve resources.

In some aspects, CPM 134 configures the control plane deployment 138 with the following functionalities:

(a) Instance Lifecycle. A control plane deployment 138 can be configured with support to manage the life cycle of control plane instances, including enabling unhealthy instances to gradually be drained from the existing workload and restart. Since local instances run on processes on the local host instead of VMs, the control plane has no control of the processes' lifecycle after processes terminate. In some aspects, an external process monitor is added to restart processes that are intended to be restarted. The local control plane monitor process tracks instances that the control plane cluster manager restarts, and restarts them after the corresponding processes exit.

(b) Local Provisioning. The control plane deployment 138 can include control plane instances that organize and manage instances in clusters (e.g., VM clusters). These instances are responsible for the creation and filling of clusters, and the provisioning of the instances is delegated to a separate cloud provisioning layer. In some aspects, requesting an instance in the local development environment 136 can include changes to mock the cloud provisioning service to spin up new processes. These newly created processes can correspond to virtual machines in the cloud infrastructure and run on different ports. This “instance in a process” has its local files that maintain metadata for the VM's startup locally. In some aspects, the mocking of the cloud provisioning service involves invoking a script that spins up a local process after a provisioning request has been registered. The mock provisioning service passes parameters to the script to configure the newly provisioned “instance in a process”. This solution supports provisioning across all types of instances and for multiple code versions.

(c) Package and Multi-Package Support. As used herein, the term “package” indicates a metadata object that encapsulates a binary of a cloud instance. Building the code for the development environment 136 produces a binary that is present in the development environment's directory. This solution disclosed herein provides support for packages across multiple code versions. This solution can be based on the control plane deployment 138 using two system functions that register and unregister a package to the instances in the development environment. To allow multi-package support, an additional field can be persisted in each instance's configuration file to declare the binary version. A repository can be set up in the development environment to hold binaries after successful builds to support packages holding multiple versions of code. The ability to run multiple packages concurrently allows the control plane deployment 138 to roll out and roll back different versions of code locally.

Other functionalities of the CPM 134 associated with the configuration of the control plane deployment 138 in the development environment 136 are discussed below in connection with FIG. 4-FIG. 24.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-Networks) coupled to one another. In alternate embodiments, these communication links are implemented using any type of communication medium and any communication protocol.

The compute service manager 108, the one or more metadata databases 112, the execution platform 110, and the storage platform 104, are shown in FIG. 1 as individual discrete components. However, each of the compute service manager 108, the one or more metadata databases 112, execution platform 110, and storage platform 104 may be implemented as a distributed system (e.g., distributed across multiple systems/platforms at multiple geographic locations). Additionally, each of the compute service manager 108, the one or more metadata databases 112, execution platform 110, and storage platform 104 can be scaled up or down (independently of one another) depending on changes to the requests received and the changing needs of the network-based database system 102. Thus, in the described embodiments, the network-based database system 102 is dynamic and supports regular changes to meet the current data processing needs.

During a typical operation, the network-based database system 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in the one or more metadata databases 112 assists the compute service manager 108 in determining which nodes in the execution platform 110 have already cached at least a portion of the data needed to process the task. One or more nodes in the execution platform 110 processes the task using data cached by the nodes and, if necessary, data retrieved from the storage platform 104. It is desirable to retrieve as much data as possible from caches within the execution platform 110 because the retrieval speed is typically much faster than retrieving data from the storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the storage platform 104. Thus, the computing resources and cache resources are not restricted to specific data storage devices 120-1 to 120-N. Instead, all computing resources and all cache resources may retrieve data from, and store data to, any of the data storage resources in the storage platform 104.

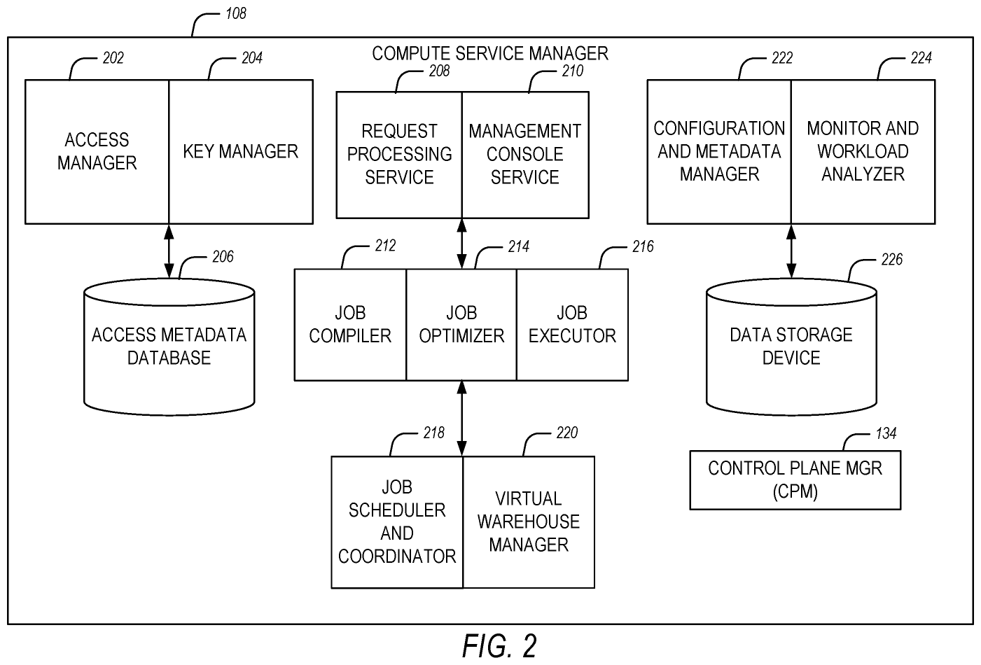

FIG. 2 is a block diagram illustrating components of the compute service manager 108, in accordance with some embodiments of the present disclosure. As shown in FIG. 2, the compute service manager 108 includes an access manager 202 and a key manager 204 coupled to an access metadata database 206, which is an example of the one or more metadata databases 112. Access manager 202 handles authentication and authorization tasks for the systems described herein. The key manager 204 facilitates the use of remotely stored credentials to access external resources such as data resources in a remote storage device. As used herein, the remote storage devices may also be referred to as “persistent storage devices” or “shared storage devices.” For example, the key manager 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the key manager 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes configuration and metadata manager 222, which manages the information related to the data stored in the remote data storage devices and the local buffers (e.g., the buffers in the execution platform 110). Configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based database system 102. For example, data storage device 226 may represent buffers in the execution platform 110, storage devices in storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing query A should not be allowed to request access to data source D (e.g., data storage device 226) that is not relevant to query A. Similarly, a given execution node (e.g., execution node 302-1 may need to communicate with another execution node (e.g., execution node 302-2), and should be disallowed from communicating with a third execution node (e.g., execution node 312-1) and any such illicit communication can be recorded (e.g., in a log or other location). Also, the information stored on a given execution node is restricted to data relevant to the current query and any other data is unusable, rendered so by destruction or encryption where the key is unavailable.

As previously mentioned, the compute service manager 108 includes the CPM 134 configured to perform the disclosed functionalities associated with distributed control plane enablement in a development environment.

FIG. 3 is a block diagram illustrating components of the execution platform 110, in accordance with some embodiments of the present disclosure. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, can access data from any of the data storage devices 120-1 to 120-N within the storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless concerning the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with execution platform 110, virtual warehouses 1, . . . , N may be implemented using multiple computing systems at multiple geographic locations. For example, virtual warehouse 1 can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location, and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location.

Execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in the storage platform 104, but each virtual warehouse has its execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

In some embodiments, at least one of the execution nodes of execution platform 110 (e.g., execution node 302-1) can be configured with the CPM 134.

Some example embodiments involve provisioning a remote account of a user—a type of account that is referred to herein at times as a “remote-deployment account,” a “remote-deployment account of a user,” a “user remote account,” and the like—with one or more replication group objects for purposes of performing replication from a source account into a target account.

It is also noted here that the terms “replication” and “refresh” (and similar forms such as “replicating,” “refreshing,” etc.) are used throughout the present disclosure. Generally speaking, “refresh” and its various forms are used to refer to a command or instruction that causes a database to start receiving one-way syncing (e.g., “pushed” updates). The term “replicate” and its various forms are used in a few different ways. In some cases, the “replicate” terms are used as a precursor to the “refresh” terms, where the “replicate” terms refer to the preparatory provisioning (populating, storing, etc.) of account objects from one user account to another user account, in some cases along with one or task objects as described herein. In this regard, the “replicate” terms relate to the replication of data from one account of a user to another account of the same user. When used in that manner, the “replicate” terms can be analogized to putting up scaffolding for a building, and the “refresh” terms can be analogized to putting up the building.

In some aspects, the “replicate” terms may also be used as a general label for what a data consumer may request (e.g., via their data provider) when the data consumer wishes to have made available to them a local instance of a given database at a given remote-deployment account of their data provider. That is, the data consumer may request “replication” of a given database of a data provider to a given remote deployment, and a data platform may responsively perform operations such as the more technical “replicate” operations (putting up the scaffolding) using one or more replication configurations and “refresh” operations (building, populating, filling in, etc.) that are also described herein.

FIG. 4 illustrates an example regional-deployment map 400 for the example database system of FIG. 1, in accordance with some embodiments of the present disclosure. The regional-deployment map 400 is presented purely by way of example and not limitation, as different numbers and/or boundaries of regions could be demarcated in different implementations. As can be seen in FIG. 4, the regional-deployment map 400 includes three example geographic regions: North American region 402, European region 404, and Asia Pacific region 406. Moreover, various instances of deployments of the network-based database system 102 are depicted on the regional-deployment map 400. A legend 408 shows symbols used for three different deployments of the network-based database system 102, including deployments that are hosted by the cloud-storage platform 122A, deployments hosted by the cloud-storage platform 122B, and deployments that are hosted by the cloud-storage platform 122C. Cloud-storage platforms 122A, 122B, and 122C can be collectively referred to as storage platforms 122, which are also illustrated in FIG. 1.

In some embodiments, CPM 134 configures the control plane deployment 138 in one or more deployment environments within at least one of the cloud-storage platforms 122A, 122B, and 122C.

FIG. 5 illustrates another view of the computing environment of FIG. 1 including control plane services (CPS), an execution platform, and object storage, in accordance with some embodiments of the present disclosure. Referring to FIG. 5, the computing environment 500 can be similar (or the same) as computing environment 100. More specifically, computing environment 500 includes a compute service manager configured to provide control plane services (CPS) 502, execution platform 504 (which can be the same as execution platform 110) including virtual warehouses 520, and object storage 506 (which can be the same as storage platform 104) including data storage devices 522.

CPS 502 is the “control plane” that provides the abstractions and connective tissue across cloud service providers to schedule and place customer jobs on the data plane as well as ensure elasticity and availability. In some aspects, CPS 502 operates a fleet of CPS instances (or CPS VMs) 508, . . . , 510 that help manage the network-based database system infrastructure and are managed independently of the data plane VMs who are responsible for running customer workloads (e.g., VMs used by the execution platform 504).

Each of the CPS instances can perform control plane functions, such as cluster management (performed by the CPS cluster manager 512), availability zone (AZ) balancing 514, autoscaling 516, and throttling 518.

In some aspects, the data plane and the control plane interact with each other to avoid system overload. As mentioned in connection with FIG. 2, CPS 502 can also include a collection of services responsible for managing and orchestrating components of the network-based database system. In some aspects, CPS 502 can run on compute VMs provisioned from cloud service providers and provides functionalities such as infrastructure management, metadata management, and query parsing and ties together different components of the data plane to manage and process user requests.

In some aspects, the CPS instances (or VMs) 508, . . . , 510 are organized in clusters, identified by the code version the VMs run on, the type of service they provide, and the customer accounts that the clusters serve. The CPS layer also supports multi-tenancy, which is the ability of a CPS cluster to provide a given control plane service to multiple customer accounts.

In some aspects, CPS 502 is responsible for VM and cluster lifecycle, health management and self-healing automation, code management, query planning, account/service placement and topology, traffic control, and resource management, including autoscaling and throttling. CPS 502 can perform functions such as deciding where each customer job runs, keeping running VMs up to date with applicable configurations, receiving metering data, logs, and metrics emitted by the data plane, deploying new software to the data plane, scaling the data plane, as well as the creation and management of the data plane.

In some aspects, the CPS cluster manager 512 performs CPS 502 administration activities. For example, the CPS cluster manager 512 is responsible for code upgrade/downgrade of deployments; creation, update, and cleanup of CPS clusters; enforcement of mapping manifests and constraints of accounts to clusters and accounts to version; interaction with a cloud provisioning service to generate and terminate cloud VMs across cloud providers; manage VMs in their lifecycle; and perform corrective actions in case of unhealthy VMs.

In some embodiments, CPS instance 508 performs AZ balancing 514. As used herein, the term “availability zone” (or AZ) indicates isolated data centers in a single region where data processing resources can be provisioned (e.g., one or more of the regions illustrated in FIG. 4). By keeping the CPS VMs balanced across these AZs, minimal customer impact is ensured in the event of zonal failures, as requests are transparently redirected to a VM in another zone.

In some embodiments, the CPS instances are configured with autoscaling 516 and throttling 518 functionalities. The throttling 518 can be resource-aware throttling, which can be referred to as dynamic throttling. As opposed to setting static concurrency limits, throttling 518 can be used to dynamically calculate concurrency limits based on current host-level resource utilization (e.g., performed every 30 seconds). When CPU load becomes high in a VM (e.g., as measured by the Linux/proc/loadavg), the host-local concurrency limits can be lowered and adjusted until the CPU load returns to and remains at an acceptable level. If this VM-level throttling results in rejections, a signal is transmitted to the autoscaling function which triggers a cluster scale-out. On the other hand, if a VM load is low, additional processing can be performed and the VM limits are increased to improve cost efficiency. To ensure fairness, concurrency limits can be computed at the account- and user-level within each VM to avoid single users or accounts in multitenant clusters from ever saturating concurrency limits and temporarily denying service from other customers.

In some aspects, to complement the VM-level throttling 518, a centralized autoscaling function (e.g., autoscaling 516) can be performed. When the aggregate resource load is high across the active VMs in a cluster or if a quorum of the cluster's VMs is rejecting work, the number of VMs in the cluster is increased. Similarly, the cluster size is reduced when no rejections are occurring and the cluster load is low to reduce costs.

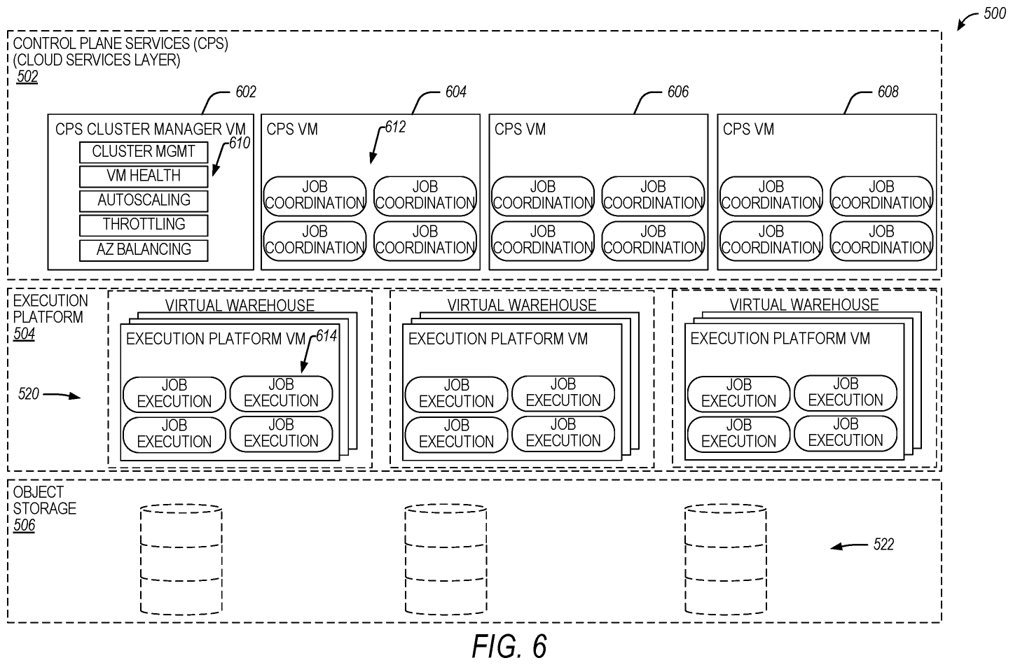

FIG. 6 is a more detailed diagram of the CPS and the execution platform of the computing environment 500 of FIG. 5, in accordance with some embodiments of the present disclosure. Referring to FIG. 6, CPS 502 can be configured with a CPS cluster manager VM 602 and a plurality of additional CPS VMs such as CPS VMs 604, 606, and 608. The CPS cluster manager VM 602 is configured to perform control plane configuration functions 610, such as cluster management, VM health management, autoscaling, throttling, and AZ balancing. Each of the CPS VMs 604-608 is configured to perform job coordination functions 612.

Each of the execution platform VMs of the virtual warehouses 520 is configured to manage job execution functions 614.

In some aspects, the computing environment 500 (e.g., as illustrated in FIG. 5 and FIG. 6) is configured as a unified architecture that allows integration and processing of data from a wide range of data sources and any type, and use it to power use case workloads (or jobs) across data lakes, data warehousing, unistore, data engineering, data science, and others. As discussed above, the computing environment 500 includes an intelligent control plane (e.g., CPS 502), an elastic data execution engine (e.g., execution platform 504), and an optimized storage layer (e.g., object storage 506). These layers are independent of each other. In some aspects, each of the cloud services layer (e.g., CPS 502) and the execution platform 504 (e.g., data plane) layer comprises a range of servers that can operate and scale independently.

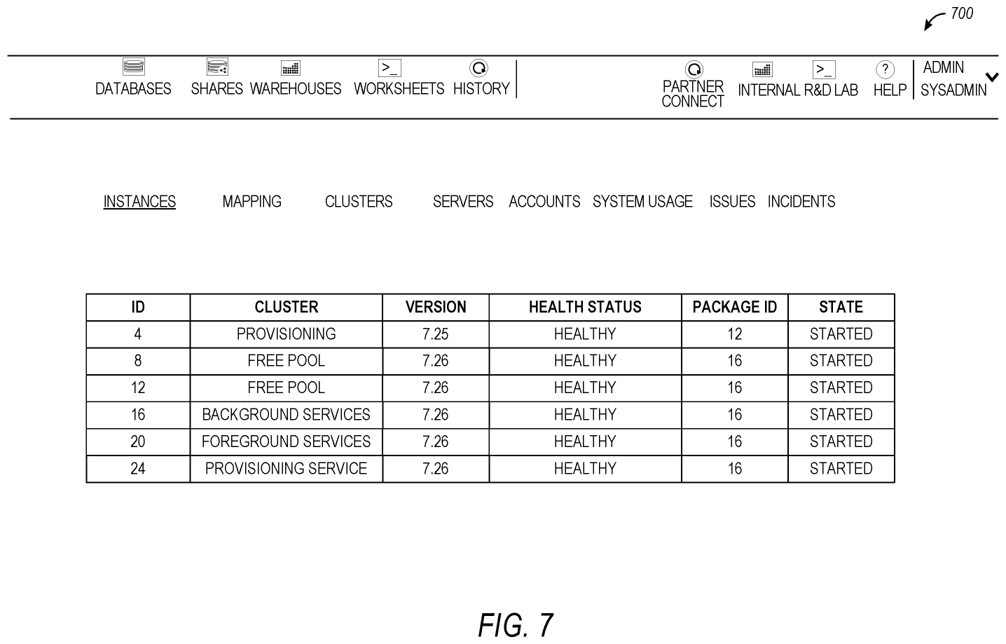

FIG. 7 is a screenshot 700 of an example CPS deployment with control plane instances in a network-based service infrastructure, in accordance with some embodiments of the present disclosure. More specifically, screenshot 700 in FIG. 7 illustrates a CPS deployment using VMs running in the deployment in respective clusters, including a background services cluster and a foreground services cluster.

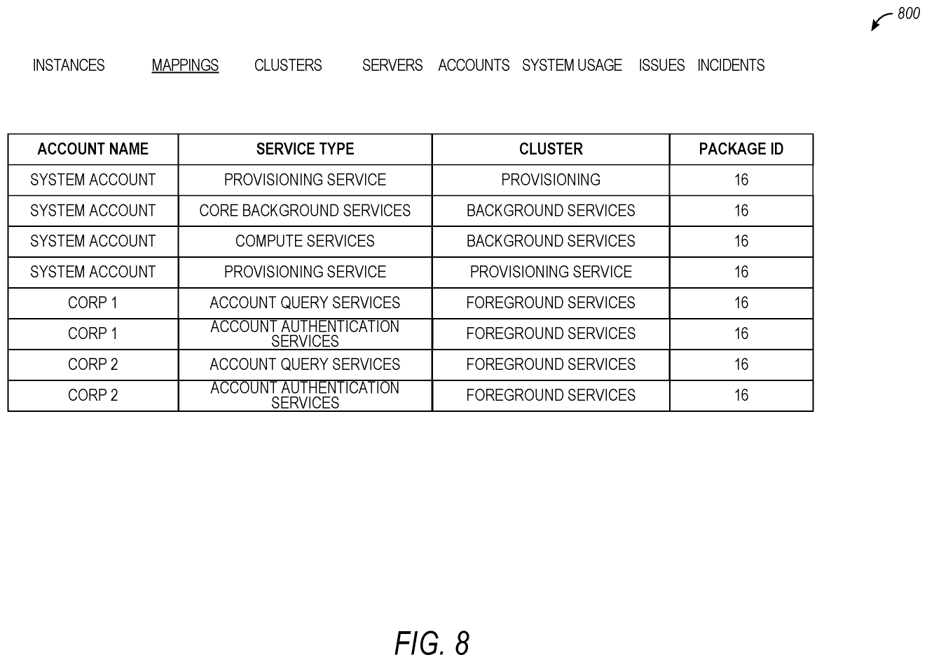

FIG. 8 is a screenshot 800 of the example CPS deployment of FIG. 7 with example mapping of accounts and services to VM clusters and packages (e.g., binary versions associated with a package ID), in accordance with some embodiments of the present disclosure.

In some embodiments, the development environment 136 (which can also be referred to as a regression environment or REG) enables setting up a testing mode that runs a limited version of the cloud services or CPS code. In some aspects, core services of the cloud services layer are disabled by default in this testing mode. In the testing mode, the cloud services' cluster manager that powers all services is not running. As a result, features like autoscaling, cluster management, management of resource pools, etc. do not run. Cloud Services run a range of clusters and require clusters to be set up for them to be enabled. In the development environment, every service can be mapped to a special local service type which prevents them from running. In this regard, the development environment allows running individual services or Java classes for testing. However, there is little to no functional testing as the distributed control plane and orchestration are not available.

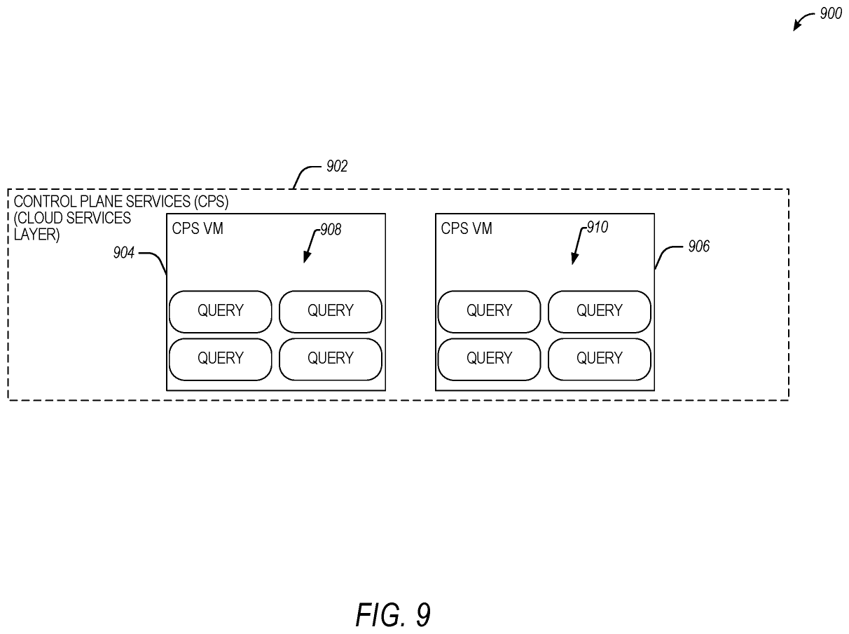

FIG. 9 is a diagram 900 of a CPS deployment in a development environment using multiple CPS VMs, in accordance with some embodiments of the present disclosure. Referring to FIG. 9, to run the limited version of the cloud services code, CPS 902 can be configured as a local testing infrastructure that spins up two operating system (OS) processes as CPS VMs 904 and 906. CPS VM 904 can be configured to process queries 908, and CPS VM 906 can be configured to process queries 910. Each of these OS processes runs the compute service manager (CSM) binary (which can also be referred to as the CPS binary) in the version the control system is currently at. In some aspects, the testing in the developer environment can run on a single node and enable test functionality that is localized. In some aspects, there are no interactions between the VMs created (e.g., CPS VMs 904 and 906) and there is no control logic running.

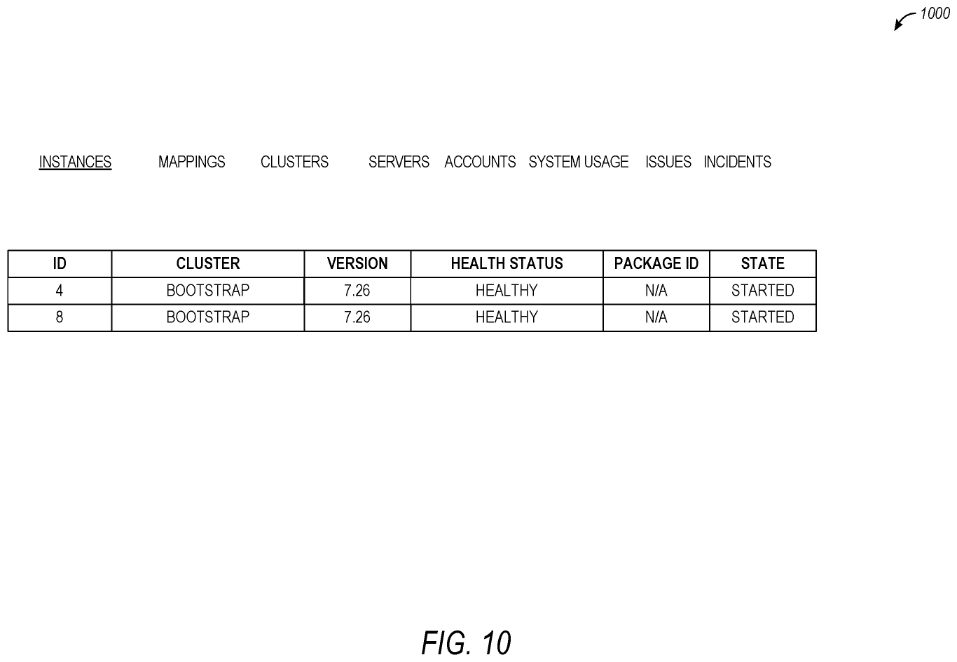

FIG. 10 is a screenshot 1000 of an example CPS deployment with control plane instances in a Bootstrap cluster in a development environment, in accordance with some embodiments of the present disclosure. Referring to FIG. 10, screenshot 1000 illustrates an example control plane deployment of CPS with two instances (e.g., CPS VMs 904 and 906 which can correspond to OS processes of the device OS hosting the development environment). The two instances are configured as part of the Bootstrap cluster, which can be the cluster with limited cloud services functionality.

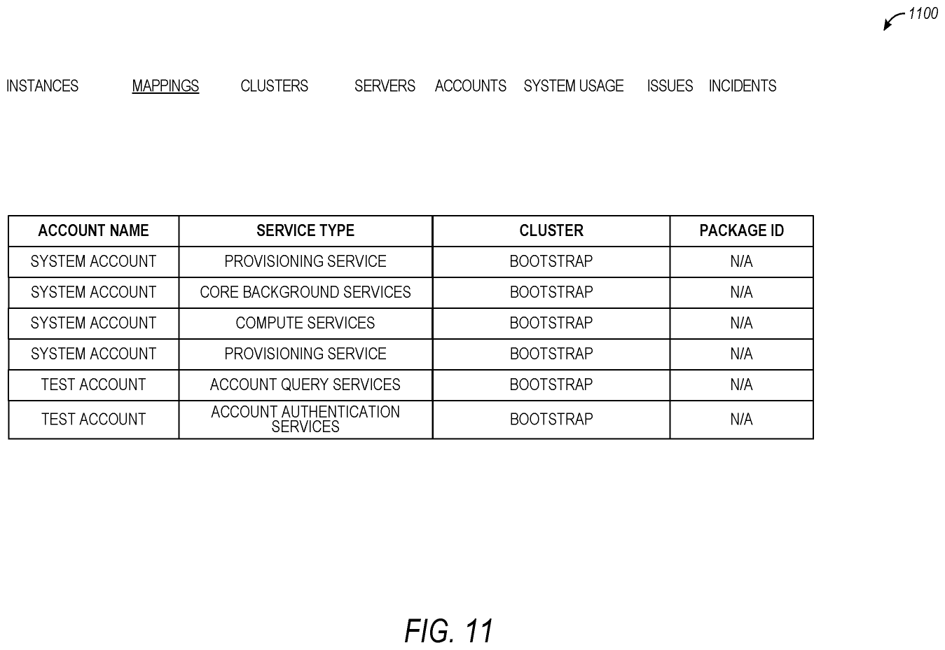

FIG. 11 is a screenshot 1100 of the example CPS deployment of FIG. 10 with an example mapping of accounts and services to VM clusters and packages, in accordance with some embodiments of the present disclosure. As illustrated in FIG. 11, all services are mapped to the Bootstrap cluster. Additionally, there is no package registered for the Bootstrap mode as it is not required for the limited functionality of the Bootstrap mode.

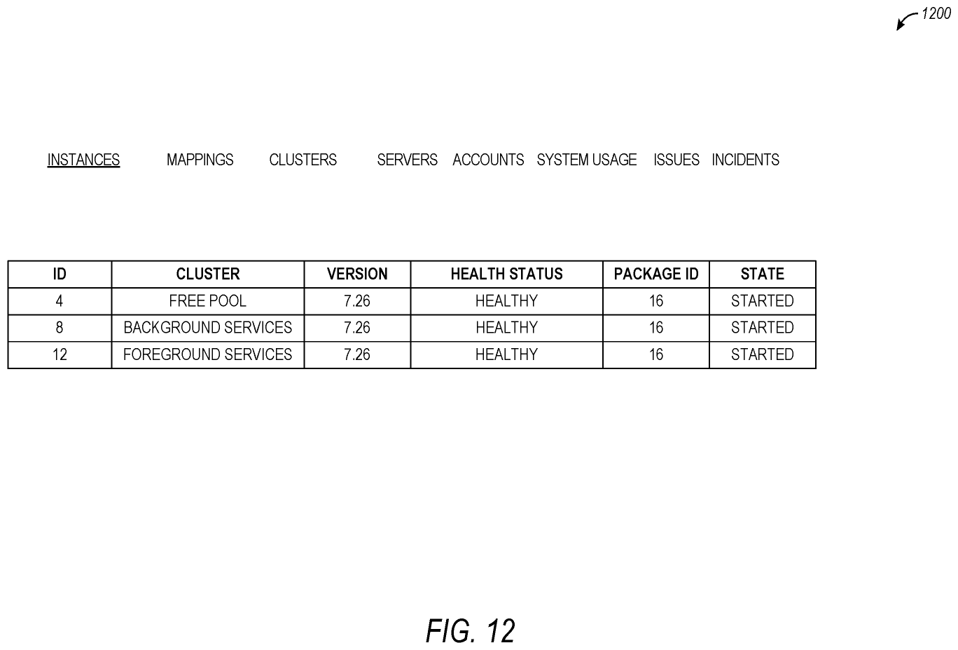

FIG. 12 is a screenshot 1200 of an example CPS deployment with control plane instances of a background and a foreground VM cluster of a development environment (e.g., development environment 136) in testing mode, in accordance with some embodiments of the present disclosure. In some aspects, control plane deployment 138 can be configured in testing mode locally, e.g., at the development environment 136 configured at a local computing device (e.g., laptop) of a development engineer. Screenshot 1200 is showing the CPS virtual machines running locally, and all services are mapped to two VM clusters (e.g., minimal background and minimal foreground VM cluster).

In some embodiments, the minimal background VM cluster (also referred to as a background VM cluster) can include a cluster manager VM (or a background VM) performing background tasks (e.g., configuration and management tasks as discussed herein, including replication and provisioning). In some aspects, the minimal foreground VM cluster (also referred to as a foreground VM cluster) can include one or more foreground VMs which can be CPS VMs configured for query processing or additional services.

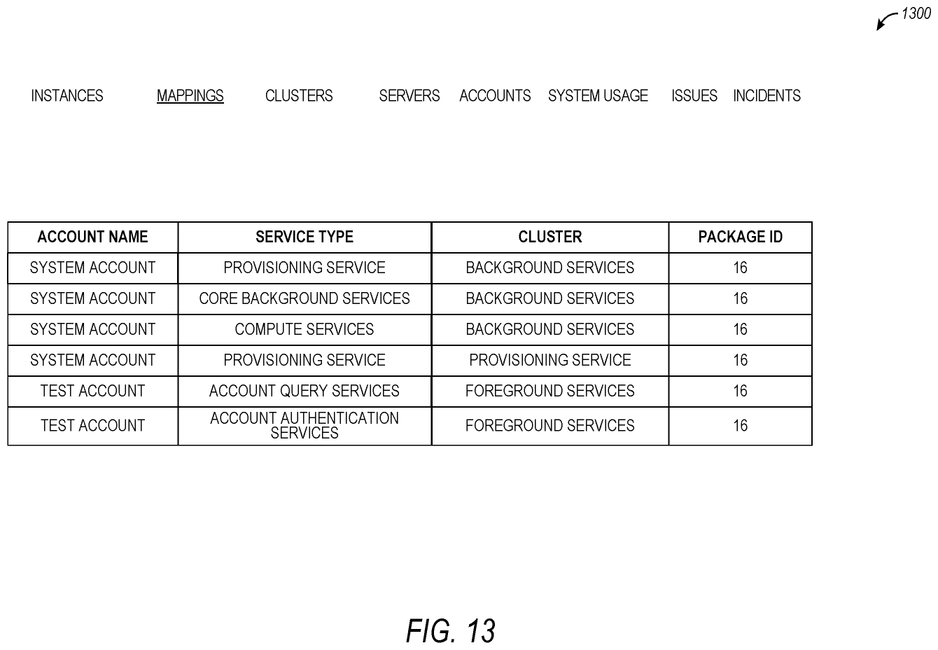

FIG. 13 is a screenshot 1300 of the example CPS deployment of FIG. 12 with an example mapping of accounts and services to the foreground VM cluster and packages, in accordance with some embodiments of the present disclosure. As seen from screenshot 1300, available services are mapped to these two clusters and a specific package version (could be mapped to more clusters and more package versions). In some aspects, CPM 134 can configure a functional deployment for the cloud services layer locally in each development/software engineer's laptop.

In some aspects, CPM 134 can configure the functional deployment for the cloud services layer to run in the regression (REG) environment outside of the default Bootstrap mode. In this regard, the control plane deployment 138 can enable testing of the control plane services (or cloud services) layer locally, setting up a minimal test deployment (mapping all services to the smallest possible number of clusters can be configured based on memory constraints in the local virtual machine), and reducing the time to test code on test deployments in the cloud, which could require multiple hours to set up a new build. The disclosed capabilities include local REG instances featuring a fully capable CPS lifecycle, provisioning of local instances, support for CPS packages locally and multiple CPS packages to support rollout and rollback, as well as having a fully functional minimal deployment in the developer VM (or DevVM). To achieve this new capability, the control plane deployment 138 can be configured to interface with the local infrastructure (e.g., the laptop's OS and other functionalities).

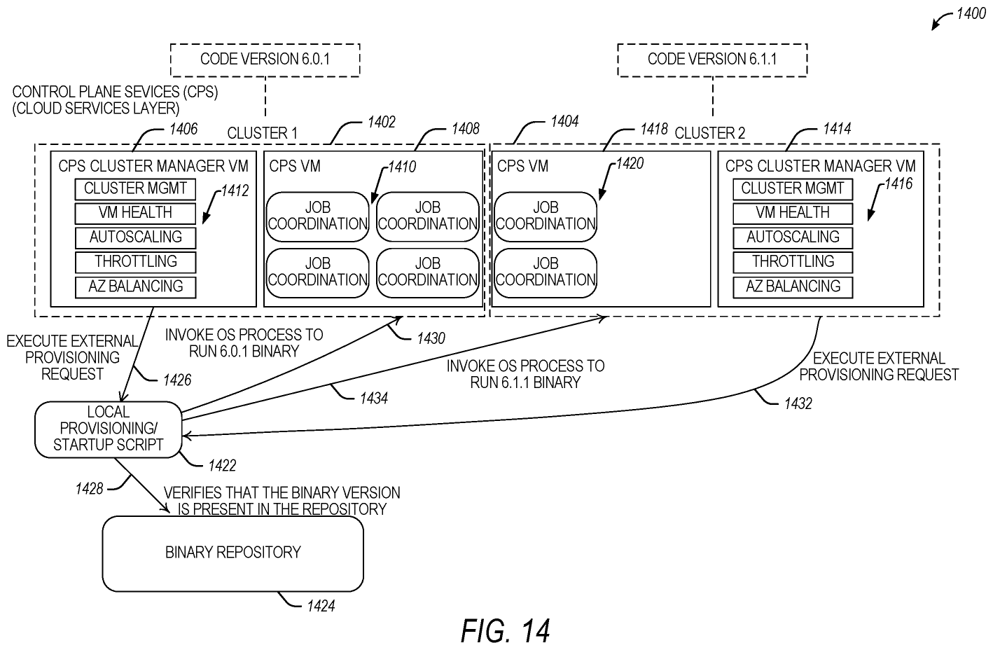

The disclosed functionalities associated with configuring the control plane deployment 138 at the development environment 136 locally (at a developer's laptop) can be controlled by a parameter. Such a parameter can be used to enable the execution of code for the control plane deployment in the regression environment, including local instances, disabling transport layer security (TLS), updating free VM pool limits, and isolation manager sensitivity. Example functionalities that the CPM 134 can configure for the control plane deployment 138 are described below in reference to FIGS. 14-23.

FIG. 14 is a diagram of a CPS deployment in a development environment with package and multi-package support, in accordance with some embodiments of the present disclosure. Referring to FIG. 14, the CPS deployment 1400 can include a first VM cluster 1402 associated with an installation package of a first code version, and a second VM cluster 1404 associated with an installation package of a second code version. The first cluster 1402 includes a cluster manager VM 1406 performing management functions 1412 and a CPS VM 1408 performing job coordination functions 1410. The second cluster 1404 includes a cluster manager VM 1414 performing management functions 1416 and a CPS VM 1418 performing job coordination functions 1420.

Packages are the metadata objects that encapsulate an RPM/image. Building the code for the regression environment produces a Java JAR file, which is present in the regression deployment's directory (e.g., the directory of the control plane deployment 138). For CPS instances to exit bootstrap mode, instances can register a package and update the service mappings. CPM 134 can provide support for packages in a development environment across multiple code versions. In some aspects, CPM 134 can configure two system functions that register and unregister a package to the instances in the regression environment based on the Java JAR file. These system functions can be run by the setup script during the startup/teardown of the control plane deployment.

In some embodiments, to allow multi-package support, an additional package field can be persisted in the REG deployment for each configuration file. In some aspects, gs_ctl.py reads the control plane deployment configuration files and starts the CPS instances with the correct package/Java JAR file. Additional options can be provided by provisioning to specify which package the control plane deployment needs to be started with. A binary repository 1424 can be set up in the deployment to hold jars of multiple packages after successful builds.

At operation 1426, the cluster manager VM 1406 executes an external provisioning request and provides metadata for a new CPS VM in cluster 1402. The external provisioning request is communicated to the local provisioning script 1422, which can be configured to execute in the local development environment 136 on the developer's laptop. In some aspects, the metadata includes the new VM ID. At operation 1428, the local provisioning script 1422 verifies the binary version (e.g., code version 6.0.1 as illustrated in FIG. 14) is present in the binary repository 1424. At operation 1430, the local provisioning script 1422 obtains the binary (e.g., code version 6.0.1 binary) from the binary repository 1424 and invokes an OS process (e.g., of the OS of the developer's laptop) to execute the binary and instantiate the new VM (e.g., CPS VM 1408).

Similar processing can be performed concerning cluster 1404. At operation 1432, the cluster manager VM 1414 executes an external provisioning request and provides metadata for a new CPS VM in cluster 1404. The external provisioning request is communicated to the local provisioning script 1422, which can be configured to execute in the local development environment 136 on the developer's laptop. In some aspects, the metadata includes the new VM ID. At operation 1428, the local provisioning script 1422 verifies the binary version (e.g., code version 6.1.1 as illustrated in FIG. 14) is present in the binary repository 1424. At operation 1434, the local provisioning script 1422 obtains the binary (e.g., code version 6.1.1 binary) from the binary repository 1424 and invokes an OS process (e.g., of the OS of the developer's laptop) to execute the binary and instantiate the new VM (e.g., CPS VM 1418).

In some embodiments, the VM lifecycle can be disabled in the developer environment. A functional control plane deployment may need support for managing VM lifecycles, including enabling sick instances to quiesce, move to quarantine, and restart, as well as supporting CPS code rollout and rollback.

In some aspects, to support VM lifecycle management in the development environment 136, the following prerequisites can be configured:

(a) The control plane deployment adds support to register packages in the development environment. A package can contain all the metadata for the CPS binary, e.g. version number. This requirement can be considered relevant as the cluster manager operates on mappings between accounts and services to clusters and packages.

(b) The control plane deployment adds support to create clusters where all the deployment's background services map to run the cluster manager.

In some aspects, since local instances run on processes in REG and are spun up by a local provisioning/startup script, the control plane deployment 138 can have limited to no control of the processes' lifecycle after processes terminate. To enable the full lifecycle management for VMs in the control plane deployment, support for VM restart can be configured. An external process monitor is added to restart processes that are intended to be restarted. The local CPS monitor process tracks CPS instances that restart and restarts them after the corresponding REG processes exit.

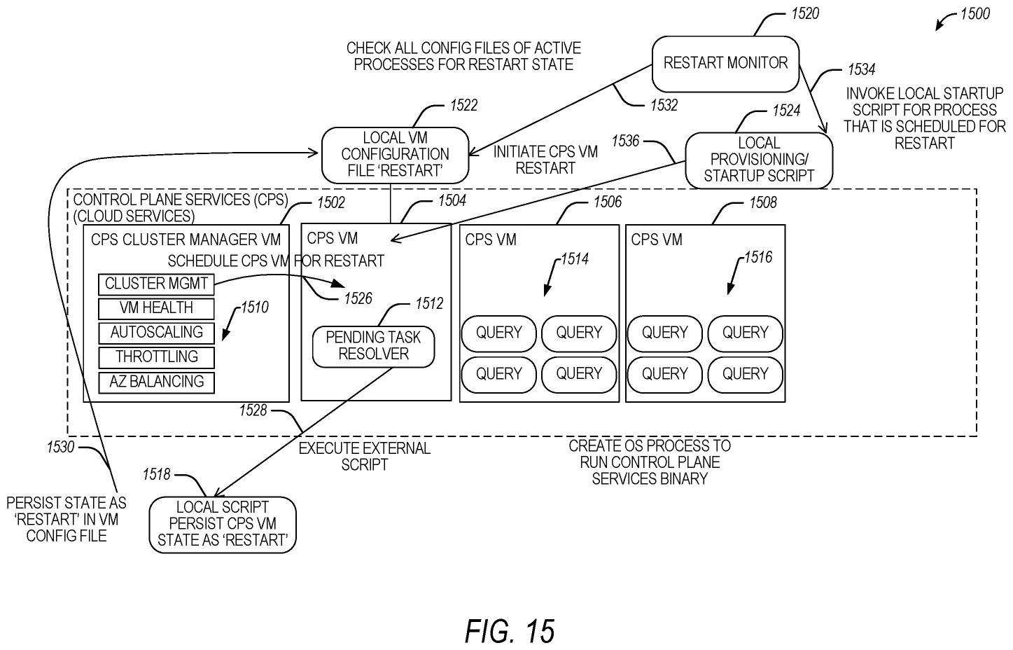

FIG. 15 is a diagram of a CPS deployment 1500 in a development environment with lifecycle management support, in accordance with some embodiments of the present disclosure. Referring to FIG. 15, the CPS deployment 1500 can include a VM cluster with a cluster manager VM 1502 performing management functions 1510 and CPS VMs 1504, 1506, and 1508. CPS VMs 1506 and 1508 performing corresponding job coordination functions 1514 and 1516.

The CPS deployment 1500 further includes a restart monitor 1520, a local script 1518 for persisting a VM state, a local VM configuration file 1522 for CPS VM 1504, and a local provisioning script 1524.

At operation 1526, the cluster manager VM 1502 schedules CPS VM 1504 for a restart. At operation 1528, the CPS cluster manager VM1512 can invoke a script (e.g., local script 1518) external to the CPS layer in the OS host to update (e.g., at operation 1530) the VM's status in the process's configuration file (e.g., the local VM configuration file 1522) for the external process monitor to restart. The restart monitor 1520 periodically checks configuration files for RESTART and if there is a process that needs to be restarted, the monitor will invoke the local startup/provisioning script, passing the correct metadata to restart the process that is pending restart. In this regard, at operation 1532, the restart monitor 1520 checks the VM configuration file 1522 for a RESTART indication and detects CPS VM 1504 has to be restarted. The restart monitor 1520 then invokes (at operation 1534) the local provisioning script 1524, passing the correct metadata to restart the corresponding OS process causing the restart of CPS VM 1504. The local provisioning script 1524, at operation 1536, causes restarting of the CPS VM 1504.

In some embodiments, the control plane deployment has a dependency on the cloud provisioning services of the network-based database system. The control plane deployment can be responsible for the creation and filling of clusters but it can only do this if it can request new VMs from the cloud provisioning service. In some aspects, requesting a VM does not translate directly into the local regression environment. Supporting the control plane deployment in the regression environment can include implementing configurations to provision local processes. In some aspects, the control plane deployment includes mocking the cloud provisioning service locally to spin up a new control plane process running on a different port instead of provisioning a new VM. This “instance in a process” has its local files that maintain metadata for the VM's startup locally. The cloud provisioning service mocking involves invoking a callable script with parameters that are running the local provisioning/startup script after a provisioning request has been registered. In some aspects, the control plane deployment supports provisioning into the VM-free pool for instances across all service types and multiple packages.

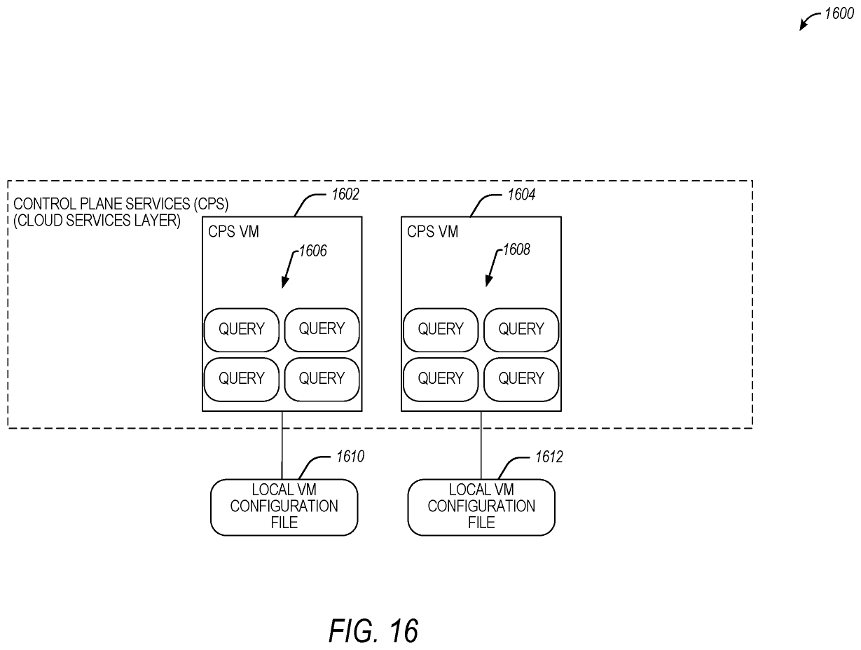

In some aspects, associated with a development environment, two virtual machines are statically created by a script, as illustrated in FIG. 16.

FIG. 16 is a diagram of a CPS deployment 1600 in a development environment with corresponding configuration files for each of the CPS VMs in the deployment, in accordance with some embodiments of the present disclosure. Referring to FIG. 16, the CPS deployment 1600 includes CPS VMs 1602 and 1604, which are configured to perform corresponding query processing functions 1606 and 1608. In some embodiments, the control plane deployment includes local VM configuration files 1610 and 1612 for CPS VMs 1602 and 1604 to maintain metadata for the local script, such as the port for each OS process used for instantiating the CPS VMN and the OS process ID.

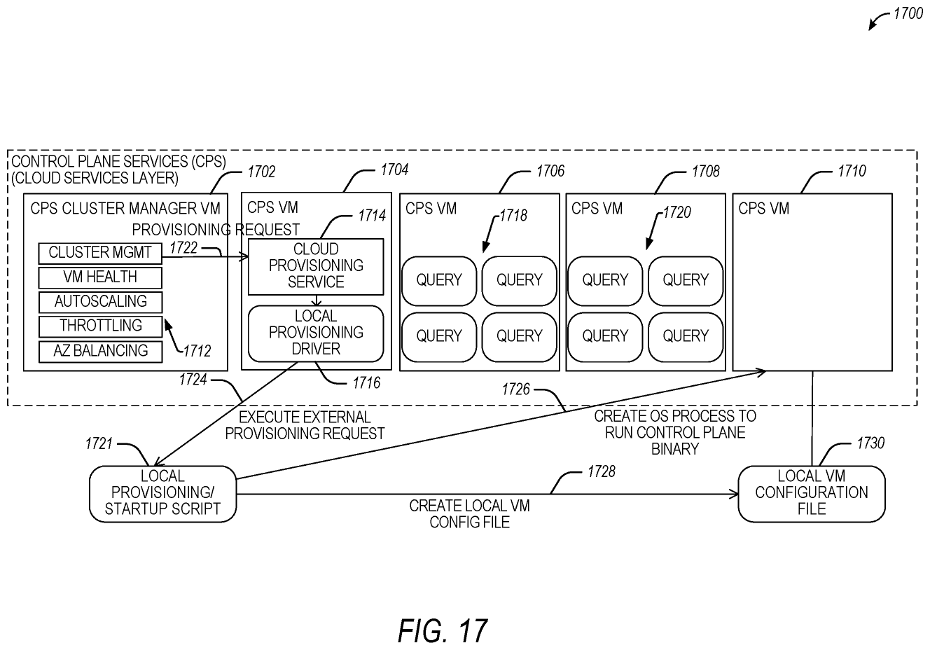

FIG. 17 is a diagram of a CPS deployment 1700 in a development environment with local provisioning of VMs using a local provisioning script, in accordance with some embodiments of the present disclosure. Referring to FIG. 17, the CPS deployment 1700 can include a VM cluster with a cluster manager VM 1702 performing management functions 1712 and CPS VMs 1704, 1706, and 1708. CPS VMs 1706 and 1708 performing corresponding job coordination and query processing functions 1718 and 1720. The CPS deployment 1700 further includes a local provisioning script 1721.

In some embodiments, the CPS deployment 1700 is configured to dynamically provision VMs running in OS processes in the development environment. For example, the cluster manager VM identifies the need to provision more instances and, at operation 1722, it sends a provisioning request to the cloud provisioning service 1714 configured in the CPS VM 1704. The cloud provisioning service 1714 invokes the local provisioning driver 1716. In production deployments, provisioning drivers of the cloud storage provider can be used instead of the local provisioning driver 1716. At operation 1724, the local provisioning driver 1716 generates a system call that runs on the OS host. The system call invokes the local provisioning script 1721 with arguments. In some aspects, the arguments include the package version and the unique identifier of the virtual machine as generated by the cluster manager (e.g., an identifier of CPS VM 1710 generated by the cluster manager VM 1702 based on the new VM provisioning request). At operation 1726, the local provisioning script 1721 starts up a new OS process to run the control plane binary with the given package version using CPS VM 1710. The local provisioning script 1721 also creates (at operation 1728) a local VM configuration file 1730 for the new virtual machine (e.g., CPS VM 1710) to maintain metadata for the process. In some aspects, the local VM configuration file 1730 is extended to include the virtual machine's ID (e.g., a unique identifier for the CPS VM 1710) and the package version.

In some embodiments, the control plane deployment 138 is configured by CPM 134 as a minimal deployment in the regression environment. The minimal deployment supports a minimal foreground cluster, a minimal background cluster, and free pool VM instances, which support multiple control plane service types. In some aspects, based on the control plane service mappings, services can be mapped to the minimal foreground cluster (also referred to as foreground services cluster) and the minimal background cluster (also referred to as background services cluster) to ensure the control plane deployment will materialize these clusters.

In some aspects, the control plane deployment 138 supports minimal deployment in a development VM (or DevVM). The minimal deployment supports the foreground services cluster, the background services cluster, and control plane free pool instances. In some aspects, automation can be configured to move the REG environment from a 2-instance bootstrap setup into the control plane minimal deployment setup at the local device and vice-versa.

In some aspects, the local deployment in the regression environment maintains metadata about control plane service instances and the processes running these instances. The local deployment also maintains a folder containing different jar versions after successful builds. In some aspects, a target Java JAR file runs the control plane deployment. A “repository” folder can be created in the same directory and all Java JAR files can be linked to the respective file in this directory upon registration of a new control plane package.

In some embodiments, automation can be introduced in the Makefile functionality to start/stop and redeploy control plane instances in the control plane deployment as well as targets to start/stop the local monitor process. In some aspects, automation can be used to enable control of the regression environment, including i) setup of a minimal control plane deployment, ii) teardown of a minimal deployment, iii) REG deployment updates that refresh the local jar repository, clean up control plane instances that are in the graveyard and update control plane instance configuration files to reflect the correct package. In some aspects, the automation script maps services to the background services and foreground services instances that comprise the minimal deployment. In some aspects, no services are mapped into the bootstrap pool of VMs.

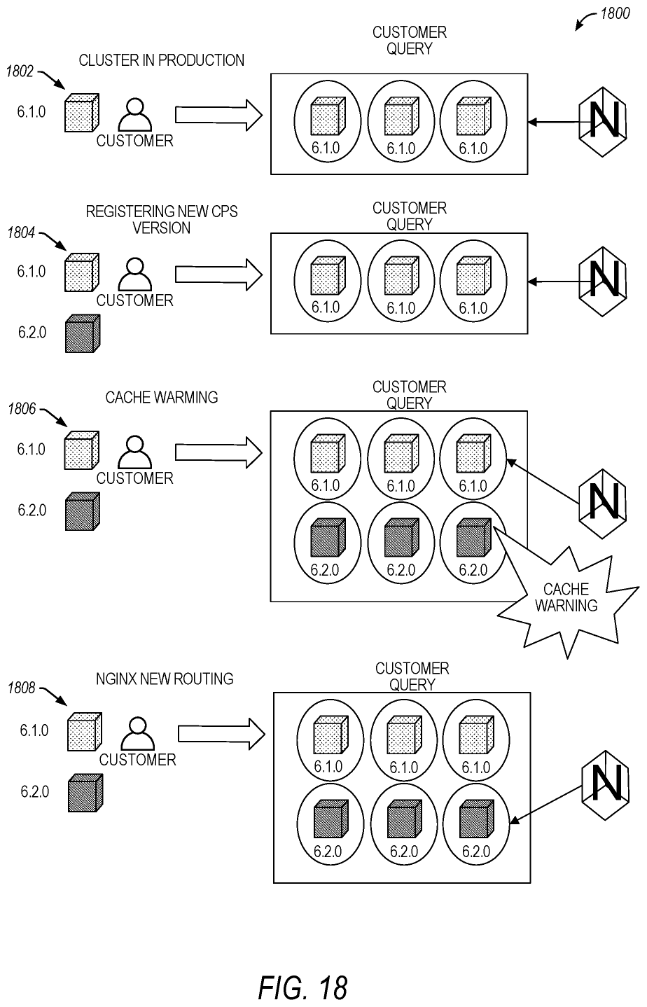

In some embodiments, functionalities illustrated in FIGS. 18-22 can be implemented in the control plane deployment 138 and can be executed locally, in the development environment 136.

FIG. 18 illustrates query processing functionalities 1800 that can be configured using a CPS deployment in a development environment, in accordance with some embodiments of the present disclosure. For example, FIG. 18 illustrates functions 1800 for creating new instances, which can include a “cluster in production” operation stage 1802, an operation stage 1804 associated with registering a new CPS version for the new VM cluster (e.g., code version 6.2.0), operation stage 1806 where a cache warning is generated that the new VM cluster and its cache are functioning, and operation stage 1808 when routing of new queries and commands is directed to the new VM cluster.

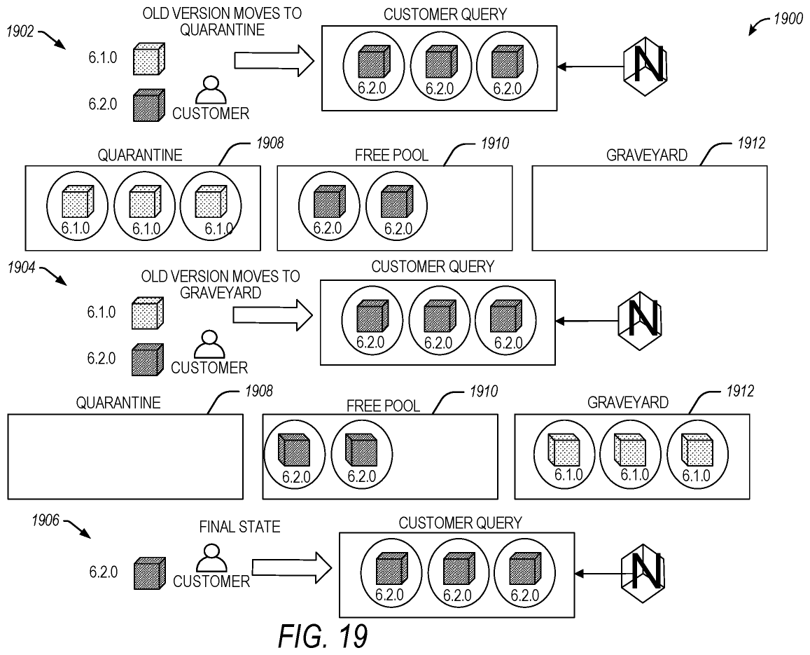

FIG. 19 illustrates query processing functionalities that can be configured using a CPS deployment in a development environment, in accordance with some embodiments of the present disclosure. For example, FIG. 19 illustrates functions 1900 associated with a new VM version rollout. At operation stage 1902, an old VM version moves to quarantine 1908. At operation stage 1904, the old VM version moves to graveyard 1912. At operation stage 1906, a new VM version (e.g., VM version 6.2.0 from the free pool 1910) is rolled out and used for query processing.

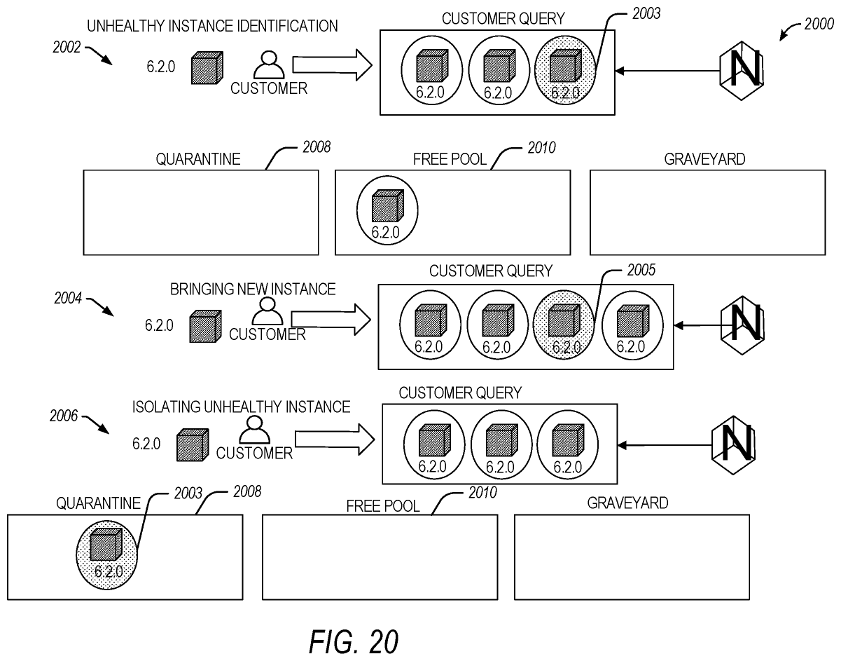

FIG. 20 illustrates query processing functionalities that can be configured using a CPS deployment in a development environment, in accordance with some embodiments of the present disclosure. For example, FIG. 20 illustrates functions 2000 associated with VM health management. At operation stage 2002, an unhealthy VM instance 2003 is identified. At operation stage 2004, a new VM instance 2005 is brought into the functioning VM cluster (e.g., based on bringing the VM from the free pool 2010 of VMs). At operation stage 2006, the unhealthy VM instance 2003 is isolated in quarantine 2008.

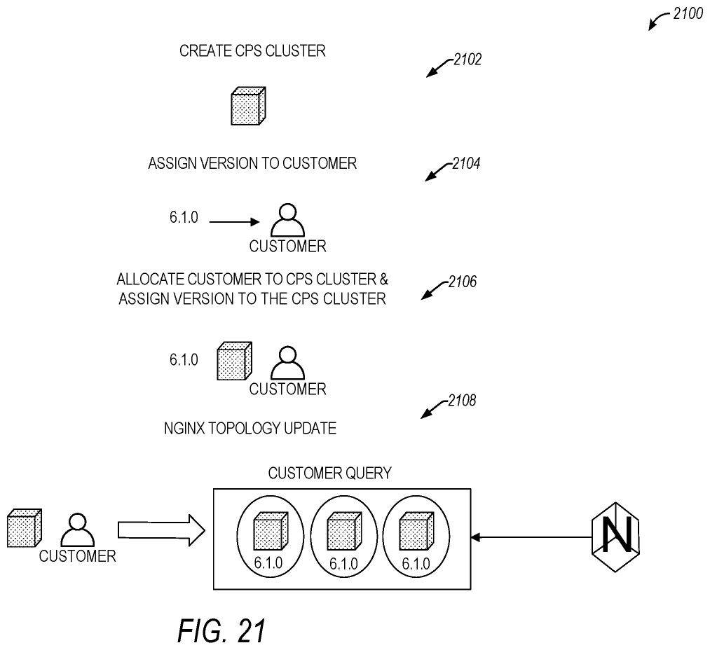

FIG. 21 illustrates query processing functionalities that can be configured using a CPS deployment in a development environment, in accordance with some embodiments of the present disclosure. For example, FIG. 21 illustrates functions 2100 associated with cluster creation. At operation stage 2102, a control plane deployment cluster of VMs is created. At operation stage 2104, a version is assigned to the customer (e.g., a control plane binary version). At operation stage 2106, the customer is allocated to the cluster and a corresponding version is assigned to the cluster. At operation stage 2108, a proxy manager is updated with the corresponding processing routing and topology for processing customer queries.

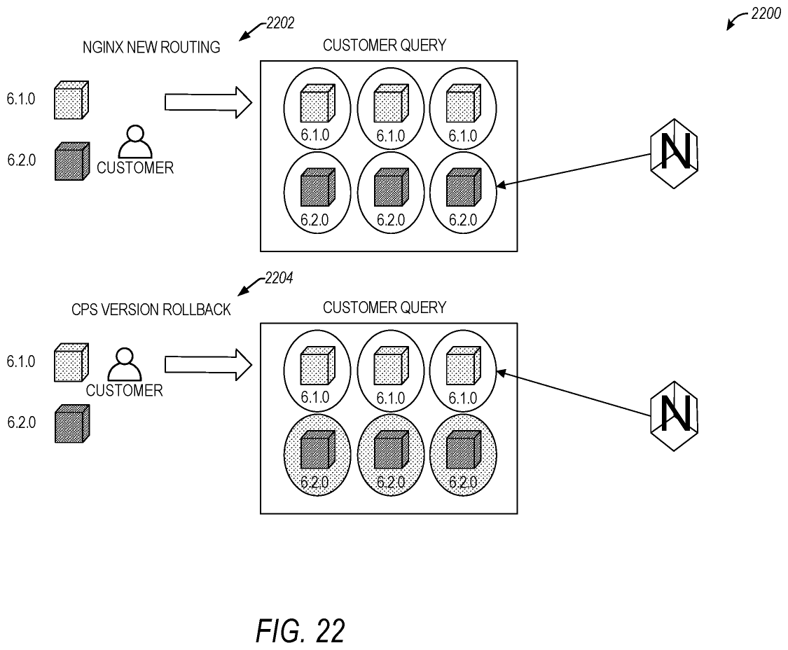

FIG. 22 illustrates query processing functionalities that can be configured using a CPS deployment in a development environment, in accordance with some embodiments of the present disclosure. For example, FIG. 22 illustrates functions 2200 associated with cluster rollback. At operation stage 2202, the proxy manager is updated with a new routing topology (e.g., instructed to use control plane binary version 6.1.0 instead of 6.2.0). At operation stage 2204, the control plane cluster is rolled back from version 6.2.0 to version 6.1.0 (e.g., due to a detected fault with control plane binary version 6.2.0).

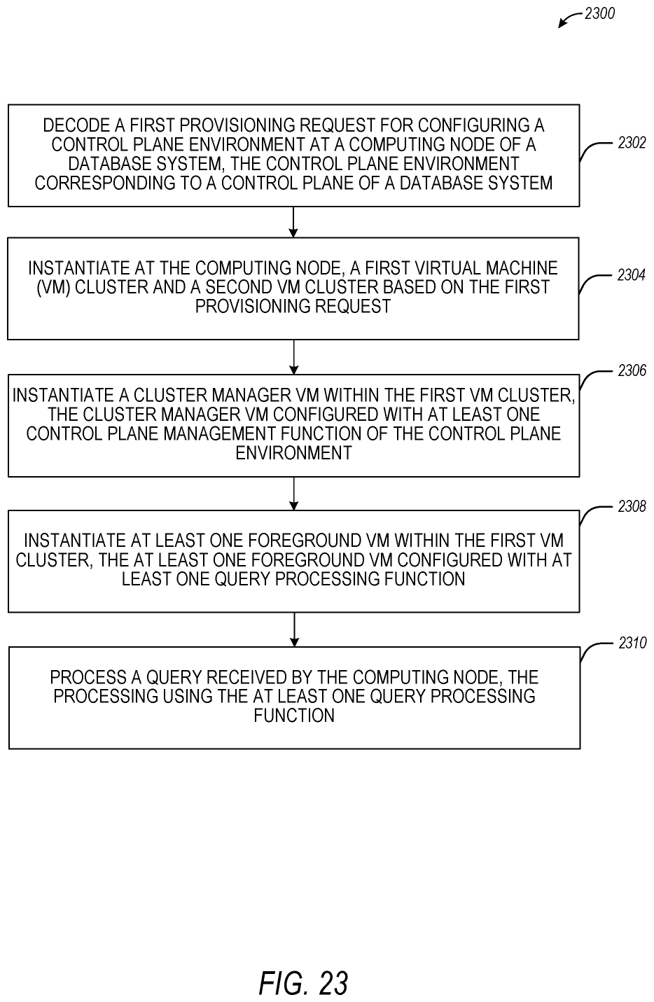

FIG. 23 is a flow diagram illustrating the operations of a database system in performing method 2300 for distributed control plane enablement in a development environment, in accordance with some embodiments of the present disclosure. Method 2300 may be embodied in computer-readable instructions for execution by one or more hardware components (e.g., one or more processors) such that the operations of method 2300 may be performed by components of the network-based database system 102, such as a network node (e.g., CPM 134 executing on a network node of the compute service manager 108) or computing device (e.g., client device 114 or a client device configured with the development environment 136) which may be implemented as machine 2400 of FIG. 24 and may be configured with an application connector performing the disclosed functions. Accordingly, method 2300 is described below, by way of example with reference thereto. However, it shall be appreciated that method 2300 may be deployed on various other hardware configurations and is not intended to be limited to deployment within the network-based database system 102.

At operation 2302, a first provisioning request for configuring a control plane environment (e.g., control plane deployment 138) is decoded at a computing node of a database system (e.g., a laptop of a development engineer of the database system). The control plane environment corresponds to a control plane of the database system (e.g., the control plane of the compute service manager 108).

At operation 2304, a first virtual machine (VM) cluster and a second VM cluster are instantiated at the computing node, based on the first provisioning request.

At operation 2306, a cluster manager VM (or a background VM) is instantiated within the first VM cluster. The cluster manager VM is configured with at least one control plane management function of the control plane environment.

At operation 2308, at least one foreground VM is instantiated within the first VM cluster. The at least one foreground VM is configured with at least one query processing function.

At operation 2310, a query received by the computing node is processed using the at least one query processing function.

FIG. 24 illustrates a diagrammatic representation of a machine 2400 in the form of a computer system within which a set of instructions may be executed for causing the machine 2400 to perform any one or more of the methodologies discussed herein, according to an example embodiment. Specifically, FIG. 24 shows a diagrammatic representation of machine 2400 in the example form of a computer system, within which instructions 2416 (e.g., software, a program, an application, an applet, an app, or other executable code) for causing the machine 2400 to perform any one or more of the methodologies discussed herein may be executed. For example, instructions 2416 may cause machine 2400 to execute any one or more operations of method 2300 (or any other technique discussed herein, for example in connection with FIG. 4-FIG. 22). As another example, instructions 2416 may cause machine 2400 to implement one or more portions of the functionalities discussed herein. In this way, instructions 2416 may transform a general, non-programmed machine into a particular machine 2400 (e.g., the client device 114, the compute service manager 108, or a node in the execution platform 110) that is specially configured to carry out any one of the described and illustrated functions in the manner described herein. In yet another embodiment, instructions 2416 may configure the client device 114, the compute service manager 108, and/or a node in the execution platform 110 to carry out any one of the described and illustrated functions in the manner described herein.

In alternative embodiments, the machine 2400 operates as a standalone device or may be coupled (e.g., networked) to other machines. In a networked deployment, machine 2400 may operate in the capacity of a server machine or a client machine in a server-client network environment, or as a peer machine in a peer-to-peer (or distributed) network environment. The machine 2400 may comprise, but not be limited to, a server computer, a client computer, a personal computer (PC), a tablet computer, a laptop computer, a netbook, a smartphone, a mobile device, a network router, a network switch, a network bridge, or any machine capable of executing the instructions 2416, sequentially or otherwise, that specify actions to be taken by the machine 2400. Further, while only a single machine 2400 is illustrated, the term “machine” shall also be taken to include a collection of machines 2400 that individually or jointly execute the instructions 2416 to perform any one or more of the methodologies discussed herein.

Machine 2400 includes processors 2410, memory 2430, and input/output (I/O) components 2450 configured to communicate with each other such as via a bus 2402. In some example embodiments, the processors 2410 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 2412 and a processor 2414 that may execute the instructions 2416. The term “processor” is intended to include multi-core processors 2410 that may comprise two or more independent processors (sometimes referred to as “cores”) that may execute instructions 2416 contemporaneously. Although FIG. 24 shows multiple processors 2410, machine 2400 may include a single processor with a single core, a single processor with multiple cores (e.g., a multi-core processor), multiple processors with a single core, multiple processors with multiple cores, or any combination thereof.

The memory 2430 may include a main memory 2432, a static memory 2434, and a storage unit 2436, all accessible to processors 2410 such as via the bus 2402. The main memory 2432, the static memory 2434, and the storage unit 2436 store the instructions 2416 embodying any one or more of the methodologies or functions described herein. The instructions 2416 may also reside, completely or partially, within the main memory 2432, within the static memory 2434, within machine storage medium 2438 of the storage unit 2436, within at least one of the processors 2410 (e.g., within the processor's cache memory), or any suitable combination thereof, during execution thereof by the machine 2400.

The I/O components 2450 include components to receive input, provide output, produce output, transmit information, exchange information, capture measurements, and so on. The specific I/O components 2450 that are included in a particular machine 2400 will depend on the type of machine. For example, portable machines such as mobile phones will likely include a touch input device or other such input mechanisms, while a headless server machine will likely not include such a touch input device. It will be appreciated that the I/O components 2450 may include many other components that are not shown in FIG. 24. The I/O components 2450 are grouped according to functionality merely for simplifying the following discussion and the grouping is in no way limiting. In various example embodiments, the I/O components 2450 may include output components 2452 and input components 2454. The output components 2452 may include visual components (e.g., a display such as a plasma display panel (PDP), a light-emitting diode (LED) display, a liquid crystal display (LCD), a projector, or a cathode ray tube (CRT)), acoustic components (e.g., speakers), other signal generators, and so forth. The input components 2454 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures or other tactile input components), audio input components (e.g., a microphone), and the like.

Communication may be implemented using a wide variety of technologies. The I/O components 2450 may include communication components 2464 operable to couple the machine 2400 to a network 2480 or devices 2470 via a coupling 2482 and a coupling 2472, respectively. For example, the communication components 2464 may include a network interface component or another suitable device to interface with network 2480. In further examples, communication components 2464 may include wired communication components, wireless communication components, cellular communication components, and other communication components to provide communication via other modalities. The devices 2470 may be another machine or any of a wide variety of peripheral devices (e.g., a peripheral device coupled via a universal serial bus (USB)). For example, as noted above, machine 2400 may correspond to any one of the client device 114, the compute service manager 108, or the execution platform 110, and devices 2470 may include the client device 114 or any other computing device described herein as being in communication with the network-based database system 102 or the storage platform 104.

The various memories (e.g., 2430, 2432, 2434, and/or memory of the processor(s) 2410 and/or the storage unit 2436) may store one or more sets of instructions 2416 and data structures (e.g., software) embodying or utilized by any one or more of the methodologies or functions described herein. These instructions 2416, when executed by the processor(s) 2410, cause various operations to implement the disclosed embodiments.

As used herein, the terms “machine-storage medium,” “device-storage medium,” and “computer-storage medium” mean the same thing and may be used interchangeably in this disclosure. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 2480 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, network 2480 or a portion of network 2480 may include a wireless or cellular network, and coupling 2482 may be a Code Division Multiple Access (CDMA) connection, a Global System for Mobile communications (GSM) connection, or another type of cellular or wireless coupling. In this example, the coupling 2482 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 2416 may be transmitted or received over the network 2480 using a transmission medium via a network interface device (e.g., a network interface component included in the communication components 2464) and utilizing any one of several well-known transfer protocols (e.g., hypertext transfer protocol (HTTP)). Similarly, instructions 2416 may be transmitted or received using a transmission medium via coupling 2472 (e.g., a peer-to-peer coupling or another type of wired or wireless network coupling) to device 2470. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 2416 for execution by the machine 2400, and includes digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some embodiments, the processor or processors may be located in a single location (e.g., within a home environment, an office environment, or a server farm), while in other embodiments the processors may be distributed across several locations.

Described implementations of the subject matter can include one or more features, alone or in combination as illustrated below by way of examples.

Example 1 is a system comprising: at least one hardware processor; and at least one memory storing instructions that cause the at least one hardware processor to perform operations comprising: decoding a first provisioning request for configuring a control plane environment at a computing node of a database system, the control plane environment corresponding to a control plane of the database system; instantiating at the computing node, a first virtual machine (VM) cluster and a second VM cluster based on the first provisioning request; instantiating a cluster manager VM within the first VM cluster, the cluster manager VM configured with at least one control plane management function of the control plane environment; instantiating at least one foreground VM within the first VM cluster, the at least one foreground VM configured with at least one query processing function; and processing a query received by the computing node, the processing using the at least one query processing function.

In Example 2, the subject matter of Example 1 includes, the operations further comprising: causing execution of a script of the control plane at the computing node, to generate the cluster manager VM and the at least one foreground VM.

In Example 3, the subject matter of Example 2 includes, the operations further comprising: executing the script of the control plane as an operating system (OS) process associated with the OS of the computing node.

In Example 4, the subject matter of Example 3 includes, the operations further comprising: configuring a first local VM configuration file and a second local VM configuration file in local storage of the computing node, the first local VM configuration file associated with the cluster manager VM and the second local VM configuration file associated with the at least one foreground VM.

In Example 5, the subject matter of Example 4 includes subject matter where each of the first local VM configuration file and the second local VM configuration file includes an ID for the OS process and a port ID for a communication port of the computing node used by the OS process during the executing of the script.

In Example 6, the subject matter of Examples 1-5 includes, the operations further comprising: detecting a second provisioning request for at least one additional foreground VM within the second VM cluster, the second provisioning request generated by the cluster manager VM; and generating the at least one additional foreground VM based on the second provisioning request.

In Example 7, the subject matter of Example 6 includes, the operations further comprising: invoking using a cloud provisioning service executing within the at least one foreground VM, a local provisioning driver of an operating system (OS) of the computing node.

In Example 8, the subject matter of Example 7 includes, the operations further comprising: generating using the local provisioning driver, a system call to a local provisioning script, the system call including at least one argument, the at least one argument associated with the at least one additional foreground VM.

In Example 9, the subject matter of Example 8 includes, the operations further comprising: determining using the local provisioning script, a software package version of a binary of the control plane, and a VM identifier of the at least one additional foreground VM based on the at least one argument.

In Example 10, the subject matter of Example 9 includes, the operations further comprising: generating using the local provisioning script, an OS process of the OS, the OS process executing the binary of the control plane in the at least one additional foreground VM associated with the VM identifier; and generating using the local provisioning script, a local VM configuration file stored at a local storage of the computing node, the local VM configuration file including an ID for the OS process and a port ID for a communication port of the computing node used by the OS process during the executing of the binary.

Example 11 is a method comprising: decoding, by at least one hardware processor, a first provisioning request for configuring a control plane environment at a computing node of a database system, the control plane environment corresponding to a control plane of the database system; instantiating at the computing node, a first virtual machine (VM) cluster and a second VM cluster based on the first provisioning request; instantiating a cluster manager VM within the first VM cluster, the cluster manager VM configured with at least one control plane management function of the control plane environment; instantiating at least one foreground VM within the first VM cluster, the at least one foreground VM configured with at least one query processing function; and processing a query received by the computing node, the processing using the at least one query processing function.

In Example 12, the subject matter of Example 11 includes, causing execution of a script of the control plane at the computing node, to generate the cluster manager VM and the at least one foreground VM.

In Example 13, the subject matter of Example 12 includes, executing the script of the control plane as an operating system (OS) process associated with the OS of the computing node.

In Example 14, the subject matter of Example 13 includes, configuring a first local VM configuration file and a second local VM configuration file in local storage of the computing node, the first local VM configuration file associated with the cluster manager VM, and the second local VM configuration file associated with the at least one foreground VM.

In Example 15, the subject matter of Example 14 includes subject matter where each of the first local VM configuration file and the second local VM configuration file includes an ID for the OS process and a port ID for a communication port of the computing node used by the OS process during the executing of the script.

In Example 16, the subject matter of Examples 11-15 includes, detecting a second provisioning request for at least one additional foreground VM within the second VM cluster, the second provisioning request generated by the cluster manager VM; and generating the at least one additional foreground VM based on the second provisioning request.

In Example 17, the subject matter of Example 16 includes, invoking using a cloud provisioning service executing within the at least one foreground VM, a local provisioning driver of an operating system (OS) of the computing node.

In Example 18, the subject matter of Example 17 includes, generating using the local provisioning driver, a system call to a local provisioning script, the system call including at least one argument, and the at least one argument associated with the at least one additional foreground VM.

In Example 19, the subject matter of Example 18 includes, determining using the local provisioning script, a software package version of a binary of the control plane, and a VM identifier of the at least one additional foreground VM based on the at least one argument.

In Example 20, the subject matter of Example 19 includes, generating using the local provisioning script, an OS process of the OS, the OS process executing the binary of the control plane in the at least one additional foreground VM associated with the VM identifier; and generating using the local provisioning script, a local VM configuration file stored at a local storage of the computing node, the local VM configuration file including an ID for the OS process and a port ID for a communication port of the computing node used by the OS process during the executing of the binary.

Example 21 is a computer-storage medium comprising instructions that, when executed by one or more processors of a machine, configure the machine to perform operations comprising: decoding a first provisioning request for configuring a control plane environment at a computing node of a database system, the control plane environment corresponding to a control plane of the database system; instantiating at the computing node, a first virtual machine (VM) cluster and a second VM cluster based on the first provisioning request; instantiating a cluster manager VM within the first VM cluster, the cluster manager VM configured with at least one control plane management function of the control plane environment; instantiating at least one foreground VM within the first VM cluster, the at least one foreground VM configured with at least one query processing function; and processing a query received by the computing node, the processing using the at least one query processing function.

In Example 22, the subject matter of Example 21 includes, the operations further comprising: causing execution of a script of the control plane at the computing node, to generate the cluster manager VM and the at least one foreground VM.

In Example 23, the subject matter of Example 22 includes, the operations further comprising: executing the script of the control plane as an operating system (OS) process associated with the OS of the computing node.

In Example 24, the subject matter of Example 23 includes, the operations further comprising: configuring a first local VM configuration file and a second local VM configuration file in local storage of the computing node, the first local VM configuration file associated with the cluster manager VM and the second local VM configuration file associated with the at least one foreground VM.

In Example 25, the subject matter of Example 24 includes subject matter where each of the first local VM configuration file and the second local VM configuration file includes an ID for the OS process and a port ID for a communication port of the computing node used by the OS process during the executing of the script.

In Example 26, the subject matter of Examples 21-25 includes the operations further comprising: detecting a second provisioning request for at least one additional foreground VM within the second VM cluster, the second provisioning request generated by the cluster manager VM; and generating the at least one additional foreground VM based on the second provisioning request.

In Example 27, the subject matter of Example 26 includes, the operations further comprising: invoking using a cloud provisioning service executing within the at least one foreground VM, a local provisioning driver of an operating system (OS) of the computing node.

In Example 28, the subject matter of Example 27 includes, the operations further comprising: generating using the local provisioning driver, a system call to a local provisioning script, the system call including at least one argument, the at least one argument associated with the at least one additional foreground VM.

In Example 29, the subject matter of Example 28 includes, the operations further comprising: determining using the local provisioning script, a software package version of a binary of the control plane, and a VM identifier of the at least one additional foreground VM based on the at least one argument.

In Example 30, the subject matter of Example 29 includes, the operations further comprising: generating using the local provisioning script, an OS process of the OS, the OS process executing the binary of the control plane in the at least one additional foreground VM associated with the VM identifier; and generating using the local provisioning script, a local VM configuration file stored at a local storage of the computing node, the local VM configuration file including an ID for the OS process and a port ID for a communication port of the computing node used by the OS process during the executing of the binary.

Example 31 is at least one machine-readable medium including instructions that, when executed by processing circuitry, cause the processing circuitry to perform operations to implement any of Examples 1-30.

Example 32 is an apparatus comprising means to implement any of Examples 1-30.

Example 33 is a system to implement any of Examples 1-30.

Example 34 is a method to implement any of Examples 1-30.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
decoding a first provisioning request for configuring a control plane environment at a computing node of a database system, the control plane environment corresponding to a control plane of the database system;
instantiating at the computing node, a first virtual machine (VM) cluster and a second VM cluster based on the first provisioning request;
instantiating a cluster manager VM within the first VM cluster, the cluster manager VM configured with at least one control plane management function of the control plane environment;
instantiating at least one foreground VM within the first VM cluster, the at least one foreground VM configured with at least one query processing function; and
processing a query received by the computing node, the processing using the at least one query processing function.

2. The system of claim 1, the operations further comprising:
causing execution of a script of the control plane at the computing node, to generate the cluster manager VM and the at least one foreground VM.

3. The system of claim 2, the operations further comprising:
executing the script of the control plane as an operating system (OS) process associated with the OS of the computing node.

4. The system of claim 3, the operations further comprising:
configuring a first local VM configuration file and a second local VM configuration file in local storage of the computing node, the first local VM configuration file associated with the cluster manager VM, and the second local VM configuration file associated with the at least one foreground VM.

5. The system of claim 4, wherein each of the first local VM configuration file and the second local VM configuration file includes an identifier (ID) for the OS process and a port ID for a communication port of the computing node used by the OS process during the executing of the script.

6. The system of claim 1, the operations further comprising:
detecting a second provisioning request for at least one additional foreground VM within the second VM cluster, the second provisioning request generated by the cluster manager VM; and
generating the at least one additional foreground VM based on the second provisioning request.

7. The system of claim 6, the operations further comprising:
invoking using a cloud provisioning service executing within the at least one foreground VM, a local provisioning driver of an operating system (OS) of the computing node.

8. The system of claim 7, the operations further comprising:
generating using the local provisioning driver, a system call to a local provisioning script, the system call including at least one argument, the at least one argument associated with the at least one additional foreground VM.

9. The system of claim 8, the operations further comprising:
determining using the local provisioning script, a software package version of a binary of the control plane, and a VM identifier of the at least one additional foreground VM based on the at least one argument.

10. The system of claim 9, the operations further comprising:
generating using the local provisioning script, an OS process of the OS, the OS process executing the binary of the control plane in the at least one additional foreground VM associated with the VM identifier; and
generating using the local provisioning script, a local VM configuration file stored at a local storage of the computing node, the local VM configuration file including an ID for the OS process and a port ID for a communication port of the computing node used by the OS process during the executing of the binary.

11. A method comprising:
decoding, by at least one hardware processor, a first provisioning request for configuring a control plane environment at a computing node of a database system, the control plane environment corresponding to a control plane of the database system;
instantiating at the computing node, a first virtual machine (VM) cluster and a second VM cluster based on the first provisioning request;
instantiating a cluster manager VM within the first VM cluster, the cluster manager VM configured with at least one control plane management function of the control plane environment;
instantiating at least one foreground VM within the first VM cluster, the at least one foreground VM configured with at least one query processing function; and
processing a query received by the computing node, the processing using the at least one query processing function.

12. The method of claim 11, further comprising:
causing execution of a script of the control plane at the computing node, to generate the cluster manager VM and the at least one foreground VM.

13. The method of claim 12, further comprising:
executing the script of the control plane as an operating system (OS) process associated with the OS of the computing node.

14. The method of claim 13, further comprising:
configuring a first local VM configuration file and a second local VM configuration file in local storage of the computing node, the first local VM configuration file associated with the cluster manager VM, and the second local VM configuration file associated with the at least one foreground VM.

15. The method of claim 14, wherein each of the first local VM configuration file and the second local VM configuration file includes an identifier (ID) for the OS process and a port ID for a communication port of the computing node used by the OS process during the executing of the script.

16. The method of claim 11, further comprising:
detecting a second provisioning request for at least one additional foreground VM within the second VM cluster, the second provisioning request generated by the cluster manager VM; and
generating the at least one additional foreground VM based on the second provisioning request.

17. The method of claim 16, further comprising:
invoking using a cloud provisioning service executing within the at least one foreground VM, a local provisioning driver of an operating system (OS) of the computing node.

18. The method of claim 17, further comprising:
generating using the local provisioning driver, a system call to a local provisioning script, the system call including at least one argument, the at least one argument associated with the at least one additional foreground VM.

19. The method of claim 18, further comprising:
determining using the local provisioning script, a software package version of a binary of the control plane, and a VM identifier of the at least one additional foreground VM based on the at least one argument.

20. The method of claim 19, further comprising:
generating using the local provisioning script, an OS process of the OS, the OS process executing the binary of the control plane in the at least one additional foreground VM associated with the VM identifier; and
generating using the local provisioning script, a local VM configuration file stored at a local storage of the computing node, the local VM configuration file including an ID for the OS process and a port ID for a communication port of the computing node used by the OS process during the executing of the binary.

21. A computer-storage medium comprising instructions that, when executed by one or more processors of a machine, configure the machine to perform operations comprising:
decoding a first provisioning request for configuring a control plane environment at a computing node of a database system, the control plane environment corresponding to a control plane of the database system;
instantiating at the computing node, a first virtual machine (VM) cluster and a second VM cluster based on the first provisioning request;
instantiating a cluster manager VM within the first VM cluster, the cluster manager VM configured with at least one control plane management function of the control plane environment;
instantiating at least one foreground VM within the first VM cluster, the at least one foreground VM configured with at least one query processing function; and
processing a query received by the computing node, the processing using the at least one query processing function.

22. The computer-storage medium of claim 21, the operations further comprising:
causing execution of a script of the control plane at the computing node, to generate the cluster manager VM and the at least one foreground VM.

23. The computer-storage medium of claim 22, the operations further comprising:
executing the script of the control plane as an operating system (OS) process associated with the OS of the computing node.

24. The computer-storage medium of claim 23, the operations further comprising:
configuring a first local VM configuration file and a second local VM configuration file in local storage of the computing node, the first local VM configuration file associated with the cluster manager VM, and the second local VM configuration file associated with the at least one foreground VM.

25. The computer-storage medium of claim 24, wherein each of the first local VM configuration file and the second local VM configuration file includes an identifier (ID) for the OS process and a port ID for a communication port of the computing node used by the OS process during the executing of the script.

26. The computer-storage medium of claim 21, the operations further comprising:
detecting a second provisioning request for at least one additional foreground VM within the second VM cluster, the second provisioning request generated by the cluster manager VM; and
generating the at least one additional foreground VM based on the second provisioning request.

27. The computer-storage medium of claim 26, the operations further comprising:
invoking using a cloud provisioning service executing within the at least one foreground VM, a local provisioning driver of an operating system (OS) of the computing node.

28. The computer-storage medium of claim 27, the operations further comprising:
generating using the local provisioning driver, a system call to a local provisioning script, the system call including at least one argument, the at least one argument associated with the at least one additional foreground VM.

29. The computer-storage medium of claim 28, the operations further comprising:
determining using the local provisioning script, a software package version of a binary of the control plane, and a VM identifier of the at least one additional foreground VM based on the at least one argument.

30. The computer-storage medium of claim 29, the operations further comprising:
generating using the local provisioning script, an OS process of the OS, the OS process executing the binary of the control plane in the at least one additional foreground VM associated with the VM identifier; and
generating using the local provisioning script, a local VM configuration file stored at a local storage of the computing node, the local VM configuration file including an ID for the OS process and a port ID for a communication port of the computing node used by the OS process during the executing of the binary.
